(19) United States
(12) Patent Application Publication
(10) Pub. No.: US 2013/0259445 A1
(43) Pub. Date: Oct. 3, 2013

(54) INFORMATION PROCESSING DEVICE, INFORMATION PROCESSING METHOD, AND PROGRAM

(71) Applicant: SONY CORPORATION, Tokyo (JP)

(72) Inventor: Hirotaka Suzuki, Kanagawa (JP)

(73) Assignee: Sony Corporation, Tokyo (JP)

(21) Appl. No.: 13/780,096

(22) Filed: Feb. 28, 2013

(30) Foreign Application Priority Data
Mar. 28, 2012 (JP) 2012-074113

(51) Int. Cl. H04N 9/87

(52) U.S. Cl. CPC H04N 9/87
USPC 386/241

(57) ABSTRACT

An information processing device includes a symbol string generating unit configured to generate a symbol string in which symbols representing attributes of a plurality of data are arrayed in time-series, based on time-series data configured of the plurality of data arrayed in time-series; and a dividing unit configured to divide the time-series data into a plurality of segments, based on dispersion of the symbols in the symbol string.

### BACKGROUND

The present disclosure relates to an information processing device, an information processing method and a program, and particularly relates to an information processing device, an information processing method and a program to divide (section) time-series data such as content or the like into cohesive segments in accordance with what is included therein.

There exists a dividing technology to divide (section) a content such as a moving image or the like into multiple segments, for example. With this dividing technology, at the time of dividing a content into segments, switching between advertisements and the main feature, or switching between people and objects in the moving image, for example, are detected as points of switching between segments (e.g., see Japanese Unexamined Patent Application Publication No. 2008-312183). The content is then divided into multiple chapters at the detected points of switching. Thus, the user can view or listen to (play) the content divided into multiple chapters, from the start of the desired chapter.

### SUMMARY

With the above-described dividing technique, for example, switching between advertisements and a main feature, or switching between people and objects in the moving image, are detected as points of switching between segments, the content may not be divided into meaningful segments in accordance with what is in the content. That is to say, with the dividing technique according to the related art, switching of sections of a broadcast program or switching of news topics may not be taken as dividing positions and the content is divided.

It has been found to be desirable to realize dividing time-series data into meaningful segments in accordance with what is included therein.

According to an embodiment, an information processing device includes: a symbol string generating unit configured to generate a symbol string in which symbols representing attributes of a plurality of data are arrayed in time-series, based on time-series data configured of the plurality of data arrayed in time-series; and a dividing unit configured to divide the time-series data into a plurality of segments, based on dispersion of the symbols in the symbol string.

The dividing unit may divide the time-series data at a position where the summation of entropy of the plurality of segments is smallest, based on dispersion of the symbols in a symbol string.

The dividing unit may divide the time-series data into segments of a number of divisions specified by specifying operations performed by a user.

The dividing unit may divide the time-series data into segments of a number of divisions where the summation of entropy is smallest, based on dispersion of the symbols in the symbol string.

The dividing unit may divide the time-series data into a plurality of segments by repeatedly performing bisection processing which divides the time-series data, at a position where the summation of entropy of segments after division is smallest, based on dispersion of the symbols in the symbol string.

The dividing unit may divide the time-series data into a plurality of segments by performing annealing partitioning processing which changes a portion where the time-series data is optionally divided, to a position where the summation of entropy is smallest, based on dispersion of the symbols in the symbol string.

The symbol string generating unit may generate, of a plurality of clusters representing subspaces making up a feature space, a symbol string made up of a plurality of symbols representing clusters including features extracted from a plurality of data configuring the time-series data.

The symbol string generating unit may generate, of a plurality of different states, a symbol string configured of a plurality of symbols representing each state of the plurality of data configuring the time-series data.

According to an embodiment, an information processing method of an information processing device includes: generating of a symbol string in which symbols representing attributes of a plurality of data are arrayed in time series, based on time-series data made up of a plurality of data arrayed in time-series; and dividing of the time-series data into a plurality of segments, based on dispersion of the symbols in the symbol string.

According to an embodiment, a program causes a computer of an information processing device which divides data to function as: a symbol string generating unit configured to generate a symbol string in which symbols representing attributes of a plurality of data are arrayed in time-series, based on time-series data configured of a plurality of data arrayed in time-series; and a dividing unit configured to divide the time-series data into a plurality of segments, based on dispersion of the symbols in the symbol string.

According to the above configurations, a symbol string, in which symbols representing attributes of a plurality of data are arrayed in time series, is generated, based on time-series data made up of a plurality of data arrayed in time-series; and the time-series data is divided into a plurality of segments, based on dispersion of the symbols in the symbol string. Thus, time-series data can be divided into meaningful segments in accordance with what is included therein.

### BRIEF DESCRIPTION OF THE DRAWINGS

FIG. 1 is a block diagram illustrating a configuration example of a recorder according to a first embodiment;

FIG. 2 is a diagram illustrating an example a symbol string which a symbol string generating unit illustrated in FIG. 1 generates;

FIG. 3 is a block diagram illustrating a configuration example of a content model learning unit illustrated in FIG. 1;

FIG. 4 is a diagram illustrating an example of left-to-right HMM;

FIG. 5 is a diagram illustrating an example of Ergodic HMM;

FIGS. 6A and 6B are diagrams illustrating examples of two-dimensional neighborhood constrained HMM which is a sparse-structured HMM;

FIGS. 7A through 7C are diagrams illustrating examples of sparse-structured HMMs other than two-dimensional neighborhood constrained HMM;

FIG. 8 is a diagram illustrating processing of extracting feature by a feature extracting unit illustrated in FIG. 3;

FIG. 9 is a flowchart for describing content model learning processing which a content model learning unit illustrated in FIG. 3 performs.

FIG. 10 is a block diagram illustrating a configuration example of the symbol string generating unit illustrated in FIG. 1;

FIG. 11 is a diagram for describing an overview of symbol string generating processing which the string generating unit illustrated in FIG. 1 performs;

FIG. 12 is a flowchart for describing symbol string generating processing which the string generating unit illustrated in FIG. 1 performs;

FIG. 13 is a diagram illustrating an example of a dividing unit illustrated in FIG. 1 dividing a content into multiple segments, based on a symbol string;

FIG. 14 is a flowchart for describing recursive bisection processing, which the dividing unit illustrated in FIG. 1 performs;

FIG. 15 is a flowchart for describing annealing partitioning processing which the dividing unit illustrated in FIG. 1 performs;

FIG. 16 is a flowchart for describing content dividing processing which a recorder illustrated in FIG. 1 performs;

FIG. 17 is a block diagram illustrating a configuration example of a recorder according to a second embodiment;

FIG. 18 is a diagram illustrating an example of chapter point data generated by a dividing unit illustrated in FIG. 17;

FIG. 19 is a diagram for describing an overview of digest generating processing which a digest generating unit illustrated in FIG. 17 performs;

FIG. 20 is a block diagram illustrating a detailed configuration example of the digest generating unit illustrated in FIG. 17;

FIG. 21 is a diagram for describing the way in which a feature extracting unit illustrated in FIG. 20 generates audio power time-series data;

FIG. 22 is a diagram illustrating an example of motion vectors in a frame;

FIG. 23 is a diagram illustrating an example of a zoom-in template;

FIG. 24 is a diagram for describing processing which an effect adding unit illustrated in FIG. 20 performs;

FIG. 25 is a flowchart for describing digest generating processing which a recorded illustrated in FIG. 17 performs;

FIG. 26 is a block diagram illustrating a configuration example of a recorder according to a third embodiment;

FIGS. 27A and 27B are diagrams illustrating the way in which chapter point data changes in accordance with specifying operations performed by a user;

FIG. 28 is a diagram illustrating an example of frames set to be chapter points;

FIG. 29 is a diagram illustrating an example of displaying thumbnail images to the right of frames set to be chapter points, in 50-frame intervals;

FIG. 30 is a first diagram illustrating an example of a display screen on a display unit;

FIG. 31 is a second diagram illustrating an example of a display screen on the display unit;

FIG. 32 is a third diagram illustrating an example of a display screen on the display unit;

FIG. 33 is a fourth diagram illustrating an example of a display screen on the display unit;

FIG. 34 is a block diagram illustrating a detailed configuration example of a presenting unit illustrated in FIG. 26;

FIG. 35 is a fifth diagram illustrating an example of a display screen on the display unit;

FIG. 36 is a sixth diagram illustrating an example of a display screen on the display unit;

FIG. 37 is a seventh diagram illustrating an example of a display screen on the display unit;

FIG. 38 is an eighth diagram illustrating an example of a display screen on the display unit;

FIG. 39 is a ninth diagram illustrating an example of a display screen on the display unit;

FIG. 40 is a flowchart for describing presenting processing which the recorder illustrated in FIG. 26 performs;

FIG. 41 is a flowchart illustrating an example of the way in which a display mode transitions; and

FIG. 42 is a block diagram illustrating a configuration example of a computer.

### DETAILED DESCRIPTION OF EMBODIMENTS

Embodiments of the present disclosure (hereinafter, referred to simply as “embodiments”) will be described. Note that description will proceed in the following order.

1. First Embodiment (example of sectioning a content into meaningful segments)

2. Second Embodiment (example of generating a digest indicating a rough overview of a content)

3. Third Embodiment (example of displaying thumbnail images for each chapter making up a content)

4. Modifications

### 1. First Embodiment

### Configuration Example of Recorder 1

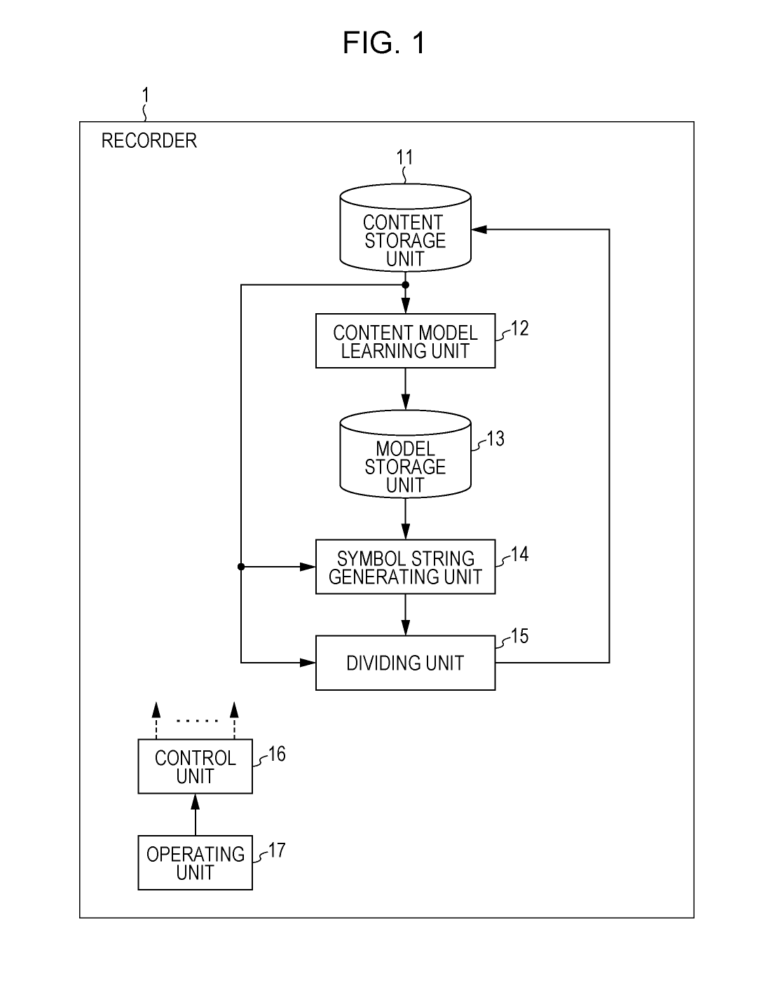

FIG. 1 illustrates a configuration example of a recorder 1. The recorder 1 in FIG. 1 is, for example, a hard disk (hereinafter may be also referred to as “HD”) recorder or the like, for example, capable of recording (storing) various types of contents, such as television broadcast programs, contents provided via networks such as the Internet, contents shot with a video camera or the like, and so forth.

In FIG. 1, the recorder 1 is configured of a content storage unit 11, a content model learning unit 12, a model storage unit 13, a symbol string generating unit 14, a dividing unit 15, a control unit 16, and an operating unit 17.

The content storage unit 11 stores (records) contents such as television broadcast programs and so forth, for example. Storing contents in the content storage unit 11 means that the contents are recorded, and the recorded contents (contents stored in the content storage unit 11 o) are played in accordance with user operations using the operating unit 17, for example.

The content model learning unit 12 structures a content or the like stored in the content storage unit 11 in a self-organizing manner in a predetermined feature space, and performs learning to obtain a model representing the structure (temporal-spatial structure) of the content (hereinafter, also referred to as “content model”), which is stochastic learning. The content model learning unit 12 supplies the content model obtained as a result of the learning to the model storage unit 13. The model storage unit 13 stores the content model supplied from the content model learning unit 12.

The symbol string generating unit 14 reads the content out from the content storage unit 11. The symbol string generating unit 14 then obtains symbols representing attributes of the frames (or fields) making up the content that has been read out, generates a symbol string where the multiple symbols obtained from each frame are arrayed in time-sequence, and supplies this to the dividing unit 15. That is to say, the symbol string generating unit 14 creates a symbol string made up of multiple symbols, using the content stored in the content storage unit 11 and the content model stored in the model storage unit 13, and supplies the symbol string to the dividing unit 15.

Now, an example of that which can be used as symbols is, of multiple clusters which are subspaces making up the feature space, cluster IDs representing clusters including the features of the frames, for example. Note that a cluster ID is a value corresponding to the cluster which that cluster ID represents. That is to say, the closer the positions of clusters are to each other, the closer values to each other the cluster IDs are. Accordingly, the greater the resemblance of features of frames is, the closer values to each other the cluster IDs are.

Also, an example of that which can be used as symbols is, of multiple state IDs representing multiple different states, state IDs representing states of the frames, for example. Note that a state ID is a value corresponding to the state which that state ID represents. That is to say, the closer the states of frames are to each other, the closer values to each other the state IDs are.

In the event that symbol IDs are employed as symbols, the frames corresponding to the same symbols have resemblance in objects displayed in the frames. Also, in the event that state IDs are employed as symbols, the frames corresponding to the same symbols have resemblance in objects displayed in the frames, and moreover, have resemblance in temporal order relation.

That is to say, in the event that cluster IDs are employed as symbols, a frame in which is displayed a train just about to leave and a frame in which is displayed a train just about to stop are assigned the same symbol. This is because that, in the event that cluster IDs are employed as symbols, frames are assigned symbols only based on whether or not objects resemble each other.

On the other hand, in the event that cluster IDs are employed as symbols, a frame in which is displayed a train just about to leave and a frame in which is displayed a train just about to stop are assigned different symbols. This is because that, in the event that state IDs are employed as symbols, frames are assigned symbols based on not only whether or not objects resemble each other, but also temporal order relation. Accordingly, in the event of employing state IDs are symbols, the symbols represent the frame attributes in greater detail as compared to a case of employing cluster IDs.

A feature of the first embodiment is that a content is divided into multiple segments based on dispersion of the symbols in a symbol string. Accordingly, with the first embodiment, in the event of employing state IDs as symbols, a content can be divided into multiple meaningful segments more precisely as compared to a case of employing cluster IDs as symbols.

Note that, in the event that learned content models are already stored in the model storage unit 13, the recorder 1 can be configured without the content model learning unit 12.

Now, we will say that data of contents stored in the content storage unit 11 include data (stream) of images audio, and text (captions) as appropriate. We will also say that in this description, out of the contents data, just image data will be used for content model learning processing and processing using content models. However, content model learning processing and processing using content models can be performed using audio data and text data besides image data, whereby the precision of processing can be improved. Further, arrangements may be made where just audio data is used for content model learning processing and processing using content models, rather than image data.

The dividing unit 15 reads out from the content storage unit 11 the same content as the content used to generate the symbol string from the symbol string generating unit 14. The dividing unit 15 then divides (sections) the content that has been read out into multiple meaningful segments, based on the dispersion of the symbols in the symbol string from the symbol string generating unit 14. That is to say, the dividing unit 15 divides a content into, for example, sections of a broadcast program, individual news topics, and so forth, as multiple meaningful segments.

Based on operating signals from the operating unit 17, the control unit 16 controls the content model learning unit 12, symbol string generating unit 14, and driving unit 15. The operating unit 17 is operating buttons or the like operated by the user, and supplies operating signals corresponding to user operations to the control unit 16, in accordance with operations by a user.

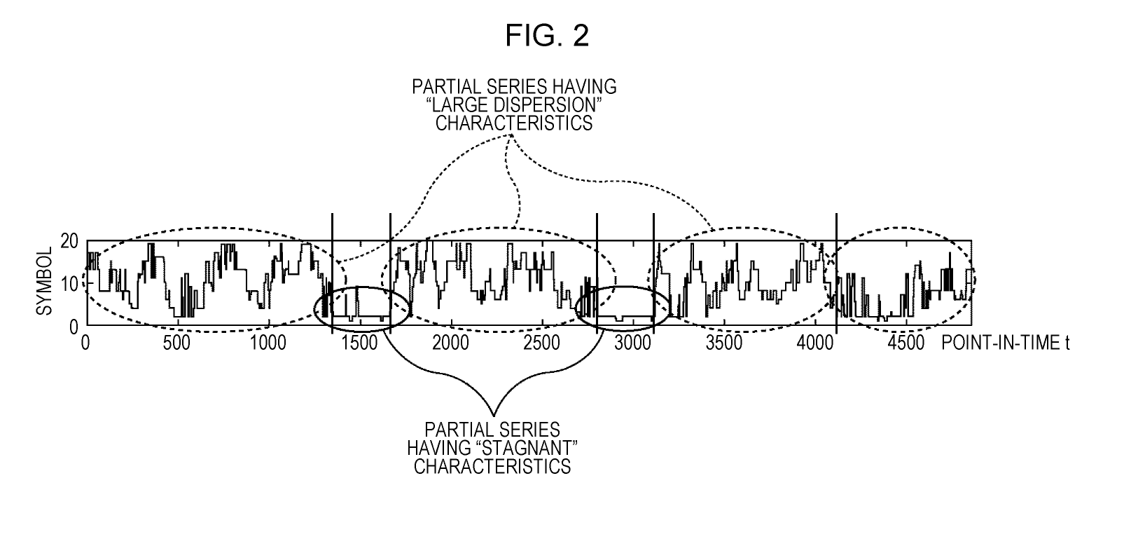

Next, FIG. 2 illustrates an example of a symbol string which the symbol string generating unit 14 generates. Note that in FIG. 2, the horizontal axis represents point-in-time t, and the vertical axis represents symbols of a frame (frame t) at point-in-time t.

Here, “point-in-time t” means a point-in-time with reference to the head of the content, and “frame t” at point-in-time t means the t′th frame from the head of the content. Note that the head frame of the content is frame 0. The closer the symbol values are to each other, the closer the attributes of the frames corresponding to the symbols are to each other.

Also, in FIG. 2, the heavy line segments extending vertically in the drawing represent partitioning lines which partition the symbol string configured of multiple symbols into six partial series. This symbol string is configured of first partial series where relatively few types of symbols are frequently observed (a partial series having “stagnant” characteristics), and second partial series where relatively many types of symbols are observed (a partial series having “large dispersion” characteristics). FIG. 2 illustrates four first partial series and two second partial series.

The Inventors performed experimentation as follows. We took multiple subjects, and had each one to draw partitioning lines so as to divide a symbol string such as illustrated in FIG. 2 into N divisions (N=6 in the case illustrated in FIG. 2).

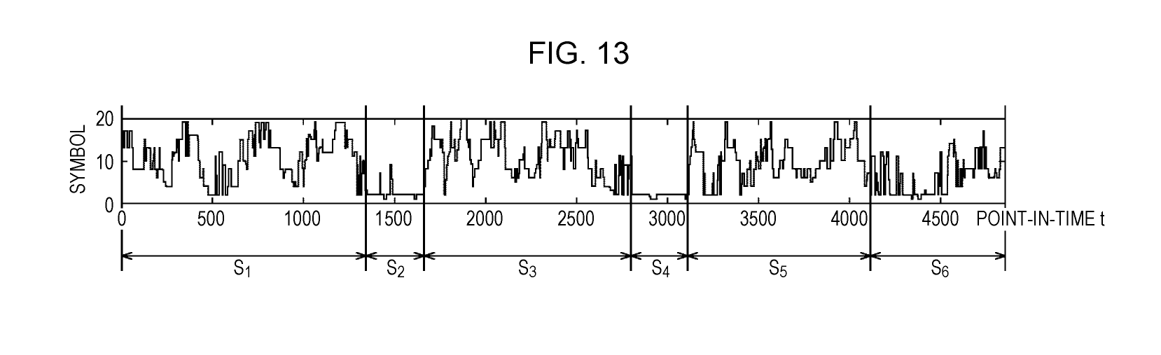

The results of the experimentation indicated that the subjects often drew the partitioning lines at boundaries between first partial series and second partial series, at boundaries between two first partial series, and at boundaries between two second partial series, in the symbol string. We also found that when the content corresponding to the symbol string illustrated in FIG. 2 was divided at the positions where the subjects drew the partitioning lines, the content was generally divided into multiple meaningful segments. Accordingly, the dividing unit 15 divides the content into multiple meaningful segments by drawing partitioning lines in the same way as the subjects, based on the symbol string from the symbol string generating unit 14. A detailed description of the specific processing which the dividing unit 15 performs will be given later with reference to FIGS. 13 through 15.

### Configuration Example of Content Model Learning Unit 12

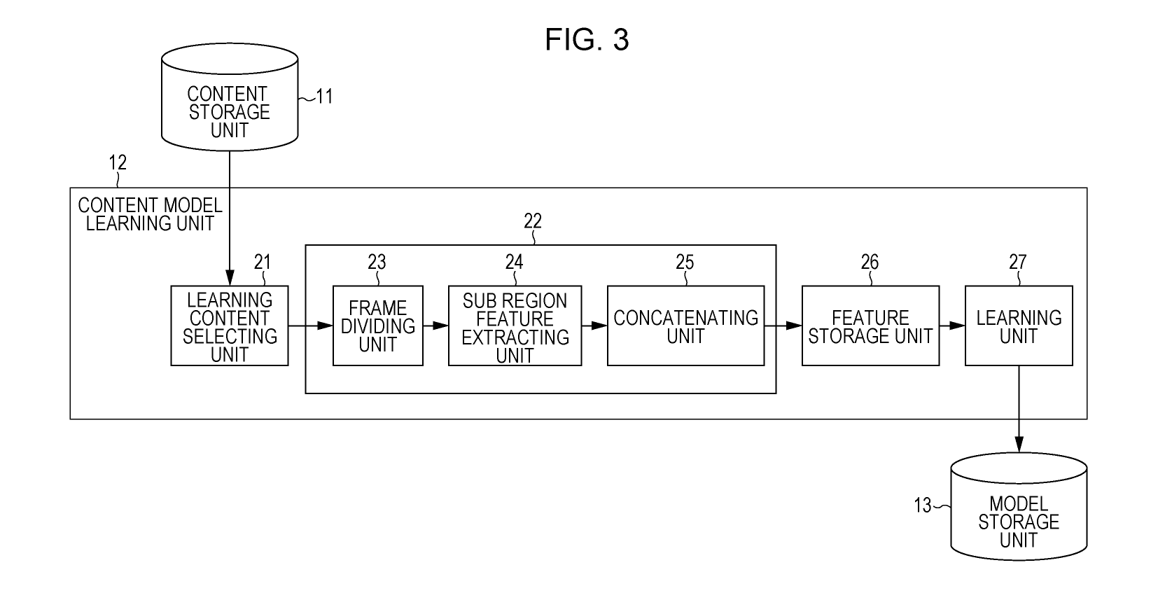

FIG. 3 illustrates a configuration example of the content model learning unit 12 illustrated in FIG. 1. The content model learning unit 12 performs learning of a state transition probability model stipulated by a state transition probability that a state will transition, and an observation probability that a predetermined observation value will be observed from the state (model learning). Also, the content model learning unit 12 extracts features for each frame of images in a learning content, which is a content used for cluster learning to obtain later-described cluster information. Further, the content model learning unit 12 performs cluster learning using features of learning contents.

The content model learning unit 12 includes a learning content selecting unit 21, a feature amount extracting unit 22, a feature amount storage unit 26 and a learning unit 27.

The learning content selecting unit 21 selects, from contents stored in the content storage unit 11, contents to user for model learning and cluster learning, as learning contents, and supplies this to the feature extracting unit 22. More specifically, the learning content selecting unit 21 selects one or more contents belonging to a predetermined category, for example, as learning contents.

The term “contents belonging to a predetermined category” means contents which share an underlying content structure, such as for example, programs of the same genre, programs broadcast regularly, such as weekly, daily, or otherwise (programs with the same title), and so forth. “Genre” can imply a very broad categorization, such as sports programs, news programs, and so forth, for example, but preferably is a more detailed categorization, such as soccer game programs, baseball game programs, and so forth. In the case of a soccer game program, for example, content categorization may be performed such that each channel (broadcasting station) makes up a different category.

We will say that what sort of categories that contents are categorized into is set beforehand at the recorder 1 illustrated in FIG. 1, for example. Alternatively, categories for categorizing the contents stored in the content storage unit 11 may be recognized from metadata such as program titles and genres and the like transmitted along with television broadcast programs, or from program information provided at Internet sites, or the like, for example.

The feature extracting unit 22 performs demultipexing (separation) of the learning contents from the learning content selecting unit 21, extracts features of each frame of the image, and supplies to the feature storage unit 26. This feature extracting unit 22 is configured of a frame dividing unit 23, a sub region feature extracting unit 24, and a concatenating unit 25.

The frame dividing unit 23 is supplied with the frames of the images of the learning contents from the learning content selecting unit 21, in time sequence. The frame dividing unit 23 sequentially takes the frames of the learning contents supplied from the learning content selecting unit 21 in time sequence, as a frame of interest. The frame dividing unit 23 divides the frame of interest into sub regions which are multiple small regions, and supplies these to the sub region feature extracting unit 24.

The sub region feature extracting unit 24 extracts the feature of these sub regions (hereinafter also referred to as “sub region feature”) from the sub regions of the frame of interest supplied from the frame dividing unit 23, and supplies to the concatenating unit 25.

The concatenating unit 25 concatenates the sub region features of the sub regions of the frame of interest from the sub region feature extracting unit 24, and supplies the results of concatenating to the feature storage unit 26 as the feature of the frame of interest. The feature storage unit 26 stores the features of the frames of the learning contents supplied from the concatenating unit 25 of the feature extracting unit 22 in time sequence.

The learning unit 27 performs cluster learning using the features of the frames of the learning contents stored in the feature storage unit 26. That is to say, the learning unit 27 uses the features (vectors) of the frames of the learning contents stored in the feature storage unit 26 to perform cluster learning where a feature space which is a space of the feature is divided into multiple clusters, and obtain cluster information, which is information of the clusters.

An example of cluster learning which may be employed is k-means clustering. In the event of using k-means as cluster learning, the cluster information obtained as a result of cluster learning is a codebook in which representative vectors representing clusters in the feature space, and code representing the representative vector vectors (or more particularly, clusters which the representative vectors represent) are correlated. Note that with k-means, the representative vector of a cluster of interest is, out of the features (vectors) of the learning contents, an average value (vector) of the features belonging to the cluster of interest (the feature of which the distance (Euclidean distance) as to the representative vector of the cluster of interest is shortest of the distances as to the representative vectors in the codebook).

The learning unit 27 further performs clustering of the features of each of the frames of the learning contests stored in the feature storage unit 26 to one of the multiple clusters, using the cluster information obtained from the learning contents, thereby obtaining the codes representing the clusters to which the features belong, thereby converting the time sequence of features of learning contents into a code series (obtains a code series of the learning contents).

Note that in the event of using k-means for cluster learning, the clustering performed using the codebook which is the cluster information obtained by the cluster learning, is vector quantization. With vector quantization, the distance as to the feature (vector) is calculated for each representative vector of the codebook, and the code of the representative vector of which the distance is the smallest is output as the vector quantization result.

Upon converting the time sequence of features of the learning contents into a code series by performing clustering, the learning unit 27 uses the code series to perform model learning which is learning of state transition models. The learning unit 27 then supplies the information processing device 13 with a set of a state transition probability model following model learning and cluster information obtained by cluster learning, as a content mode, correlated with the category of the learning content. Accordingly, a content model is configured of a state transition probability model and cluster information.

Note that a state transition probability model making up a content model (a state transition probability model where learning is performed using a code series) may also be referred to as “code model” hereinafter.

### State Transition Probability Model

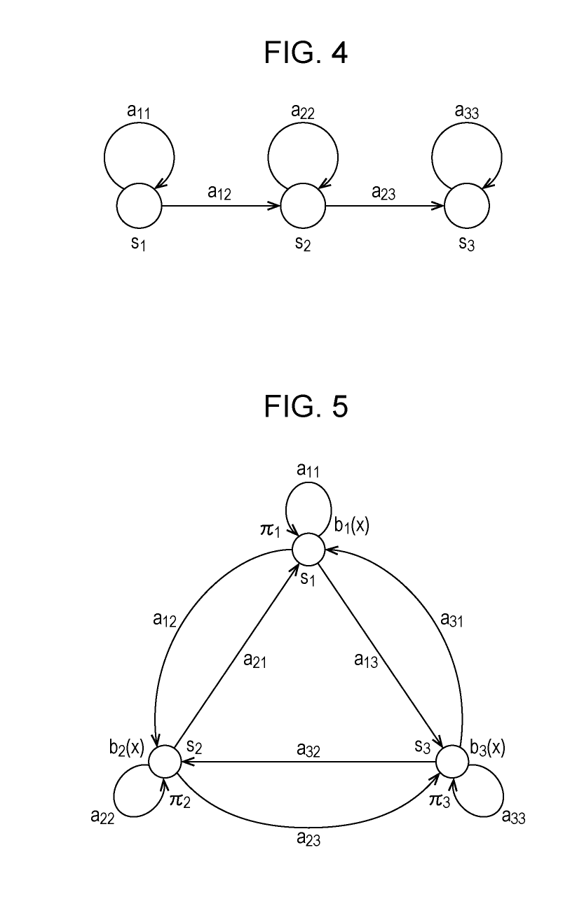

State transition probability models regarding which the learning unit 27 illustrated in FIG. 3 perform model learning will be described with reference to FIGS. 4 through 7C. An example of a state transition probability model is a Hidden Markov Model (hereinafter may be abbreviated to “HMM”) In the event of employing HMM as a state transition probability model, HMM learning is performed by Baum-Welch re-estimation, for example.

FIG. 4 illustrates an example of a left-to-right HMM. A left-to-right HMM is an HMM where states are aligned on a signal straight line from left to right, in which self-transition (transition from a state to that state) and transition from a state to a state to the right of that state can be performed. Left-to-right HMMs are used with speech recognition, for example, and so forth.

The HMM in FIG. 4 is configured of three states; s1, s2, and s3. Permitted state transitions are self-transition and transition from a state to the state at the right thereof.

Note that an HMM is stipulated by an initial probability πᵢ of a state sᵢ, a state transition probability and an observation probability bᵢ(o) that a predetermined observation value o will be observed from the state sᵢ. Note that the initial probability πᵢ is the probability that the state sᵢ will be the initial state (beginning state), and with a left-to-right HMM the initial probability πᵢ that the state sᵢ will be at the leftmost state s₁ is 1.0, and the initial probability πᵢ that the state sᵢ will be at another state sᵢ is 0.0.

The state transition probability aᵢⱼ is the probability that a state sᵢ will transition to a state sⱼ.

The observation probability bᵢ(o) is the probability that an observation value o will be observed in state sᵢ when transitioning to state sᵢ. While a value serving as a probability (discrete value) is used for the observation probability b₁(o) in the event that the observation value o is a discrete value, in the event that the observation value o is a continuous value a probability distribution function is used. An example of a probability distribution function which can be used is Gaussian distribution defined by mean values (mean vectors) and dispersion (covariance matrices), for example, or the like. Note that with the present embodiment, a discrete value is used for the observation value o.

FIG. 5 illustrates an example of an Ergodic HMM. An Ergodic HMM is an HMM where there are no restrictions in state transition, i.e., state transition can occur from any state sᵢ to any state sᵢ. The HMM in FIG. 5 is configured of three states; s₁, s₂, and s₃, with any state transition allowed.

While an Ergodic HMM has the highest degree of freedom of state transition, depending on the initial values of the parameters of the HMM (initial probability πᵢ, state transition probability aᵢⱼ, and observation probability bᵢ(o)), the HMM may converge on a local minimum, without suitable parameters being obtained.

Accordingly, we will employ a hypothesis that “almost all natural phenomena, and camerawork and programming whereby video contents are generated, can be expressed by sparse combination such as with small-world networks”, and an HMM where state transition is restricted to a sparse structure will be employed.

Note that here, a “sparse structure” means a structure where the states to which state transition can be made from a certain state are very limited (a structure where only sparse state transitions are available), rather than a structure where the states to which state transition can be made from a certain state are dense as with an Ergodic HMM. Also note that, although the structure is sparse, there will be at least one state transition available to another state, and also self-transition exists.

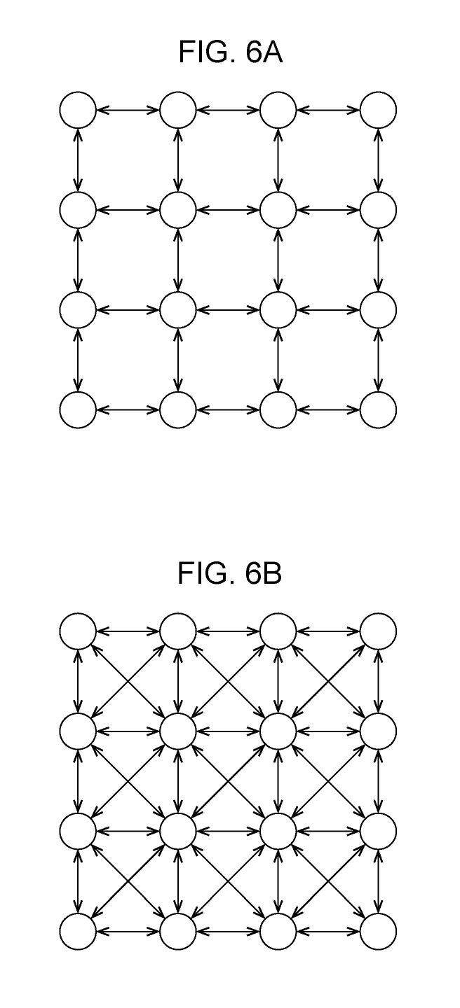

FIGS. 6A and 6B illustrate examples of two-dimensional neighborhood constrained HMMs. The HMMs in FIGS. 6A and 6B are restricted in that the structure is sparse, and in that the states making up the HMM are situated on a grid on a two-dimensional plane. The HMM illustrated in FIG. 6A has state transition to other states restricted to horizontally adjacent states and vertically adjacent states. The HMM illustrated in FIG. 6B has state transition to other states restricted to horizontally adjacent states, vertically adjacent states, and diagonally adjacent state.

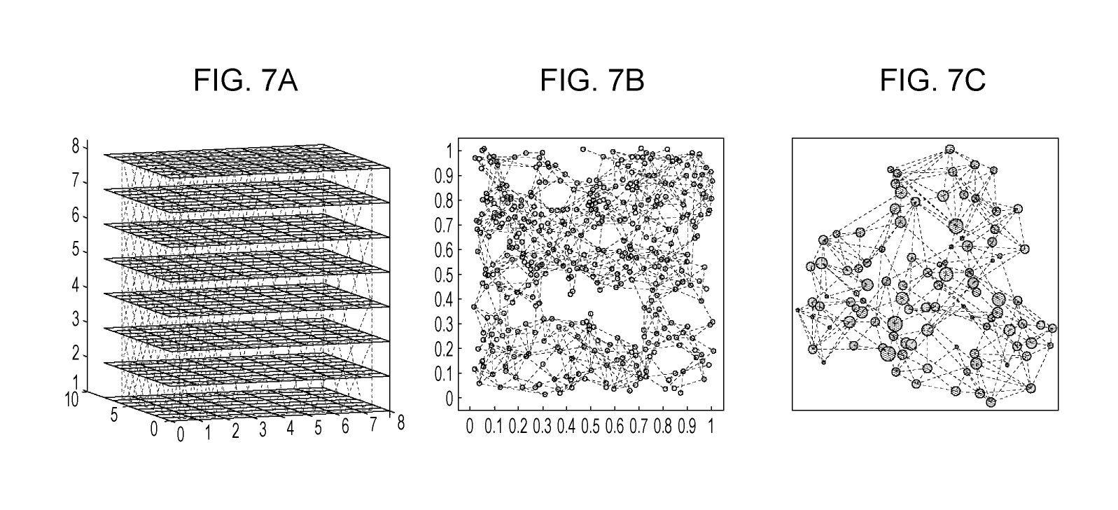

FIGS. 7A through 7C are diagrams illustrating examples of sparse-structured HMMs other than two-dimensional neighborhood constrained HMM. That is to say, FIG. 7A illustrates an example of an HMM with three-dimensional grid restriction. FIG. 7B illustrates an example of an HMM with two-dimensional random array restrictions. FIG. 7C illustrates an example of an HMM according to a small-world network.

With the learning unit 27 illustrated in FIG. 3, learning of an HMM with a sparse structure such as illustrated in FIGS. 6A through 7B, having around a hundred to several hundred states, is performed by Baum-Welch re-estimation using the code series of features extracted from frames of images stored in the feature storage unit 26.

An HMM which is a code mode obtained as the result of the learning at the learning unit 27 is obtained by learning using only the image (visual) features of the content, so we will refer to this as “Visual HMM” here. The code series of features used for HMM learning (model learning) is discrete values, and probability values are used for the observation probability bᵢ(o) of the HMM.

Further description of HMMs can be found in “Fundamentals of Speech Recognition”, co-authored by Laurence Rabiner and Biing-Hwang Juang, and in Japanese Patent Application No. 2008-064993 by the Present Assignee. Further description of usage of Ergodic HMMs and sparse-structure HMMs can be found in Japanese Unexamined Patent Application Publication No. 2009-223444 by the Present Assignee.

### Extraction of Features

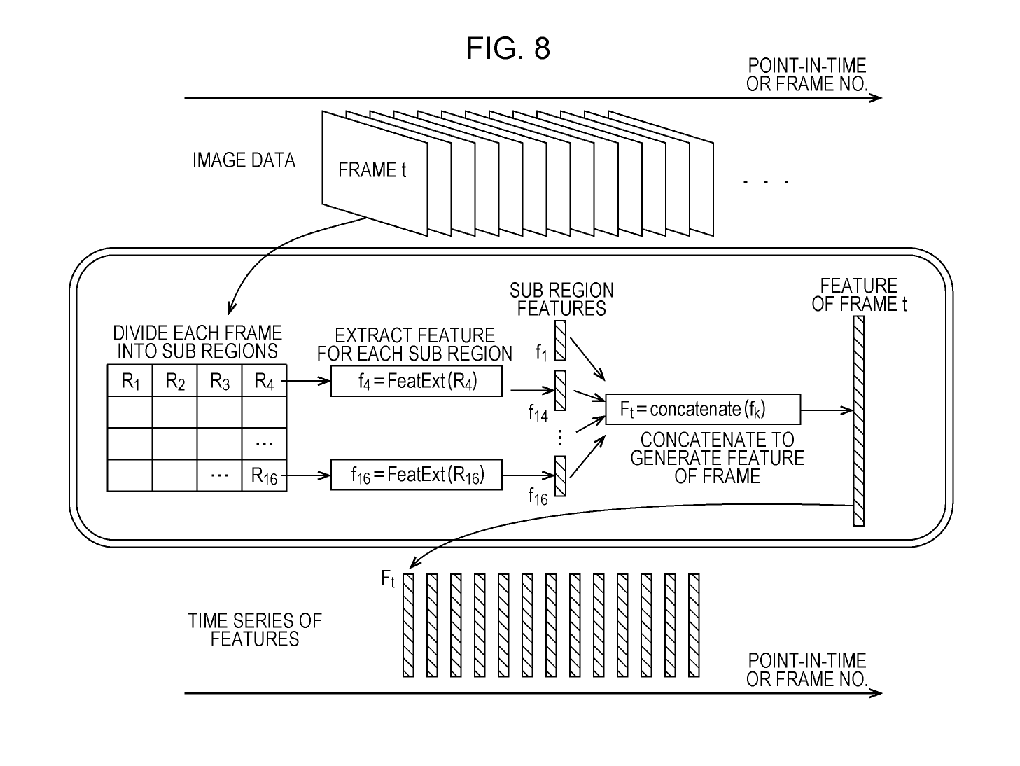

FIG. 8 illustrates processing of feature extraction by the feature extracting unit 22 illustrated in FIG. 3. At the feature extracting unit 22, the image frames of the learning contents from the learning content selecting unit 21 are supplied to the frame dividing unit 23 in time sequence. The frame dividing unit 23 sequentially takes the frames of the learning content supplied in time sequence from the learning content selecting unit 21 as the frame of interest, and divides the frame of interest into multiple sub regions Rₖ, which are then supplied to the sub region feature extracting unit 24.

FIG. 8 illustrates a frame of interest having been equally divided into 16 sub regions R₁, R₂, and so on through R₁₆, each being 4×4, vertically×horizontally. However, dividing of one frame into sub regions Rₖ is not restricted to the number of sub regions Rₖ being 4×4=16; rather, other ways of dividing may be used, such as the number of sub regions Rₖ being 5×4=20, the number of sub regions Rₖ being 5×5=25, and so forth, for example.

Also, while FIG. 8 illustrates one frame being divided equally into sub regions Rₖ of the same size, the sizes of the sub regions Rₖ do not have to be all the same. That is to say, an arrangement may be made wherein, for example, the middle portion of the frame is divided into sub regions of small sizes, and portions at the periphery of the frame (portions adjacent to the image frame and so forth) are divided into sub regions of larger sizes.

The sub region feature extracting unit 24 illustrated in FIG. 3 extracts the sub region feature fₖ=FeatExt(Rₖ) for each sub region Rₖ of the frame of interest from the frame dividing unit 23, and supplies this to the concatenating unit 25. That is to say, the sub region feature extracting unit 24 uses pixel values of the sub regions Rₖ (e.g., RGB components, YUV components, etc.) to obtain global features of the sub regions Rₖ as sub region features fₖ.

Here, “global features of the sub regions Rₖ” means features calculated additively using only pixels values, and not using information of the position of the pixels making up the sub regions Rₖ, such as histograms for example. As an example of global features, GIST may be employed. Details of GIST may be found in, for example, “A. Torralba, K. Murphy, W. Freeman, M. Rubin, ‘Context-based vision system for place and object recognition’, IEEE Int. Conf. Computer Vision, vol. 1, no. 1, pp. 273-280, 2003”.

Note that global features are not restricted to those according to GIST; rather, any feature system which can handle change in local position, luminosity, viewpoint visibility and so forth in a robust manner, may be used. Examples of such include Higher-order Local AutoCorrelation (hereinafter also referred to as “HLAC”), Local Binary Patterns (hereinafter also referred to as “LBP”), color histograms, and so forth.

Detailed description of HLAC can be found in, for example, “N. Otsu, T. Kurita, ‘A new scheme for practical flexible and intelligent vision systems’, Proc. IAPR Workshop on Computer Vision, pp. 431-435, 1988”. Detailed description of LBP can be found in, for example, “Ojala T, Pietikäinen M & Maenpää T, ‘Multiresolution gray-scale and rotation invariant texture classification with Local Binary Patterns’, IEEE Transactions on Pattern Analysis and Machine Intelligence 24(7):971-987”.

Now, while global features such as GIST, LBP, HLAC, color histograms, and so forth mentioned above tend to have higher dimensions, but also tend to have higher correlation between dimensions. Accordingly, with the sub region feature extracting unit 24 illustrated in FIG. 3, after GIST or the like has been extracted from a sub region Rₖ, principal component analysis (also abbreviated to “PCA”) can be performed for the GIST or the like. The sub region feature extracting unit 24 can compress (restrict) the number of dimensions of GIST so that the cumulative contribution ratio is a fairly high value (e.g., a value of 95% or more, for example), based on the results of PCA, and the compression results can be taken as the sub region features. In this case, projection vectors of GIST or the like on PCA space with compressed number of dimensions are the compression results with the number of dimensions of GIST or the like compressed.

The concatenating unit 25 illustrated in FIG. 3 concatenates sub region features f₁ through f₁₆, and supplies the concatenating results thereof to the feature storage unit 26 as the feature of the frame of interest. That is to say, the concatenating unit 25 concatenates the sub region features f₁ through f₁₆ from the sub region feature extracting unit 24, thereby generating vectors of which the sub region features f₁ through f₁₆ are components, and supplies the vectors to the feature storage unit 26 as the feature Ft of the frame of interest. Note that in FIG. 8, the frame at point-in-time t (frame t) is the frame of interest.

The feature extracting unit 22 illustrated in FIG. 3 takes the frames of the learning contents in order from the head as the frame of interest, and obtains feature Ft as described above. The feature Ft of each frame of the learning contents is supplied from the feature extracting unit 22 to the feature storage unit 26 in time sequence (in a state with the temporal order maintained), and is stored.

Thus, global features of sub regions Rₖ are obtained as sub region features fₖ at the feature extracting unit 22, and vectors having the sub region features fₖ as components thereof are obtained as the feature Ft of the frame. Accordingly, the feature Ft of the frame is a feature which is robust as to local change (change occurring within sub regions), but is discriminative as to change in pattern array for the overall frame.

### Content Model Learning Processing

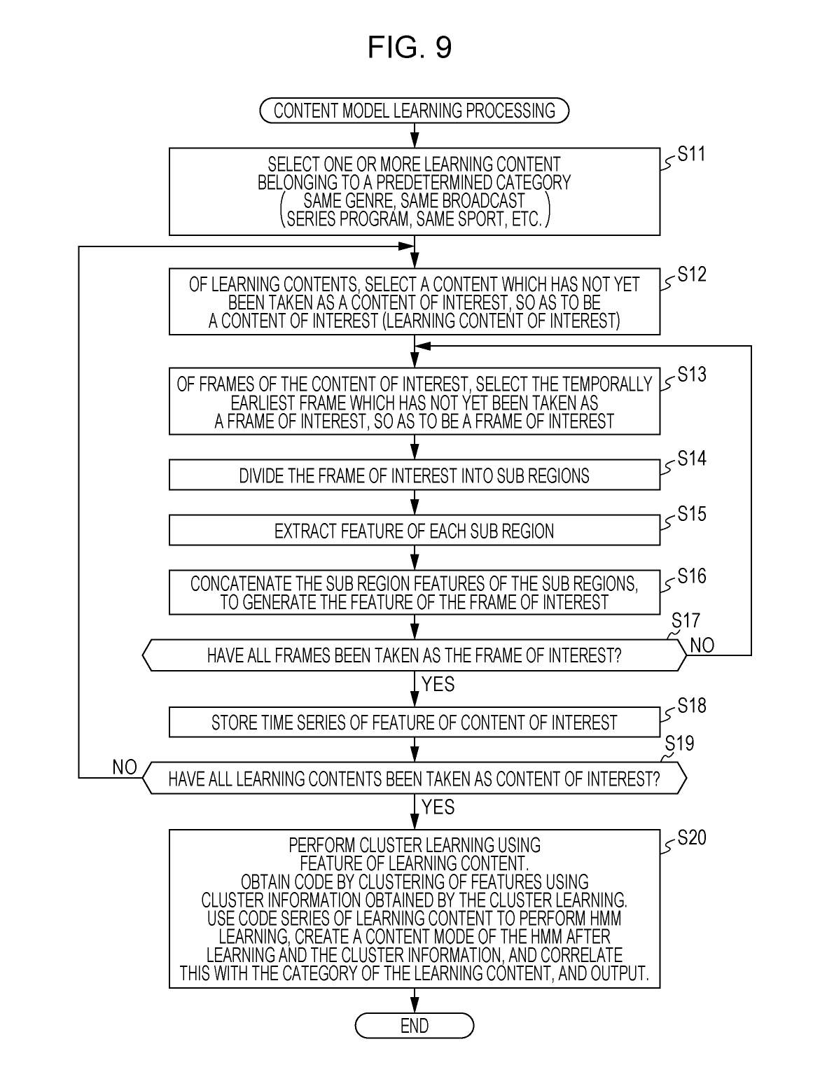

Next, processing which the content model learning unit 12 illustrated in FIG. 3 performs (content model learning processing) will be described with reference to the flowchart in FIG. 9.

In step S11, the learning content selecting unit 21 selects, from contents stored in the content storage unit 11, one or more contents belonging to a predetermined category, as learning contents. That is to say, the learning content selecting unit 21 selects, from contents stored in the content storage unit 11, any one content not yet taken as a learning content, as a learning content. Further, the learning content selecting unit 21 recognizes the category of the one content selected as the learning content, and in the event that another content belonging to that category is stored in the content storage unit 11, further selects that other content as a learning content. The learning content selecting unit 21 supplies the learning content to the feature extracting unit 22, and the flow advances from step S11 to step S12.

In step S12, the frame dividing unit 23 of the feature extracting unit 22 selects, from the learning contents from the learning content selecting unit 21, of learning content not yet selected as a learning content of interest (hereinafter may be referred to simply as “content of interest”), as the content of interest.

The flow then advances from step S12 to step S13, where the frame dividing unit 23 selects, of the frames of the content of interest, the temporally foremost frame that has not yet been taken as the frame as interest, as the frame of interest, and the flow advances to step S14.

In step S14, the frame dividing unit 23 divides the frame of interest into multiple sub regions, which are supplied to the sub region feature extracting unit 24, and the flow advances to step S15.

In step S15, the sub region feature extracting unit 24 extracts the sub region features of each of the multiple sub regions from the frame dividing unit 23, supplies to the concatenating unit 25, and the flow advances to step S16.

In step S16, the concatenating unit 25 concatenates the sub region features of each of the multiple sub regions making up the frame of interest, thereby generating a feature of the frame of interest, and the flow advances to step S17.

In step S17, the frame dividing unit 23 determines whether or not all frames of the content of interest have been taken as the frame of interest. In the event that determination is made in step S17 that there remains a frame in the frames of the content of interest that has yet to be taken as the frame of interest, the flow returns to step S13, and the same processing is repeated. Also, in the event that determination is made in step S17 that all frames in the content of interest have been taken as the frame of interest, the flow advances to step S18.

In step S18, the concatenating unit 25 supplies the time series of the features of the frames of the content of interest, obtained regarding the content of interest, to the feature storage unit 26 so as to be stored.

The flow then advances from step S18 to step S19, and the frame dividing unit 23 determines whether all learning contents from the learning content selecting unit 21 have been taken as the content of interest. In the event that determination is made in step S19 that there remains a learning content in the learning contents that has yet to be taken as the content of interest, the flow returns to step S12, and the same processing is repeated. Also, in the event that determination is made in step S19 that all learning contents have been taken as the content of interest, the flow advances to step S20.

In step S20, the learning unit 27 performs learning of the content model, using the features of the learning contents (the time sequence of the features of the frames) stored in the feature storage unit 26. That is to say, the learning unit 27 performs cluster learning where the feature space that is the space of the features is divided into multiple clusters, by k-means clustering, using the features (vectors) of the frames of the learning contents stored in the feature storage unit 26, and obtains a codebook of a stipulated number, e.g., one hundred to several hundred clusters (representative vectors) as cluster information.

Further, the learning unit 27 performs vector quantization in which the features of the frames of the learning contents stored in the feature storage unit 26 are clustered, using a codebook serving as cluster information that has been obtained by cluster learning, and converts the time sequence of the features of the learning contents into a code series.

Upon converting the time sequence of the features of the learning contents into a code series by performing clustering, the learning unit 27 uses this code series to perform model learning which is HMM (discrete HMM) learning. The learning unit 27 then outputs (supplies) to the information processing device 13 a set of a state transition probability model following model learning and a codebook serving as cluster information obtained by cluster learning, as a content mode, correlated with the category of the learning content, and the content model learning processing ends. Note that the content model learning processing may start at any timing.

According to the content model learning processing described above, in an HMM which is a code model, the structure of a content (e.g., structure created by programming and camerawork and the like) underlying in the learning contents can be acquired in a self-organizing manner. Consequently, each state of the HMM serving as a code model in the content model obtained by the content model learning processing corresponds to a component of the structure of the content acquired by learning, and state transition expresses temporal transition among components of the content structure. In the feature space (space of features extracted by the feature extracting unit 22 illustrated in FIG. 3), the state of the code model collectively represents a frame group of which temporal distance is close and also resembles in temporal order relation (i.e., “similar scenes”).

### Configuration Example of Symbol String Generating Unit 14

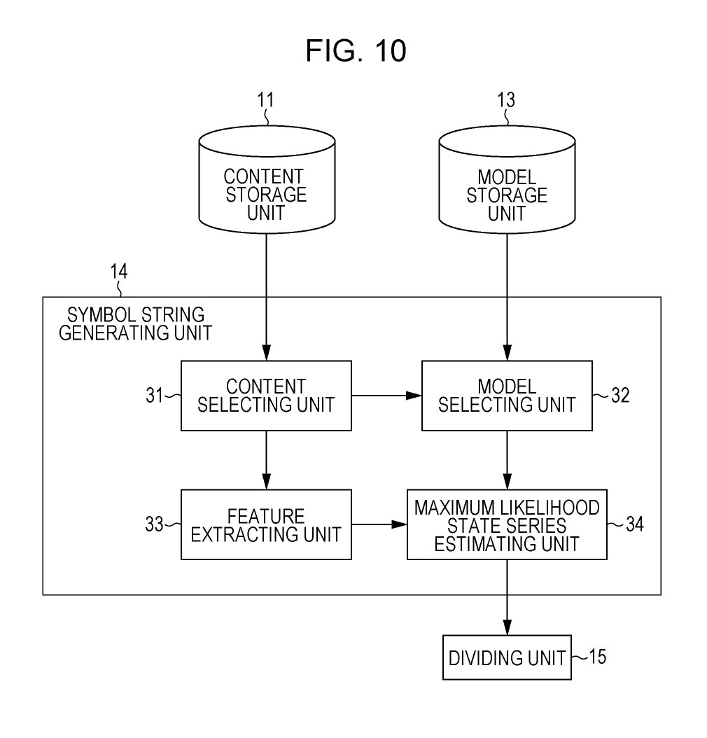

FIG. 10 illustrates a configuration example of the symbol string generating unit 14 illustrated in FIG. 1. The symbol string generating unit 14 includes a content selecting unit 31, a model selecting unit 32, a feature extracting unit 33, and a maximum likelihood state series estimating unit 34.

The content selecting unit 31, under control of the control unit 16, selects, from the contents stored in the content storage unit 11, a content for generating a symbol string, as the content of interest. Note that the control unit 16 controls the content selecting unit 31 based on operation signals corresponding user operations at the operating unit 17, so as to select the content selected by user operations as the content of interest. Also, the content selecting unit 31 supplies the content of interest to the feature extracting unit 33. Further, the content selecting unit 31 recognizes the category of the content of interest and supplies this to the model selecting unit 32.

The model selecting unit 32 selects, from the content models stored in the model storage unit 13, a content model of a category matching the category of the content of interest from the content selecting unit 31 (a content model which has been correlated with the category of the content of interest), as the model of interest. The model selecting unit 32 then supplies the model of interest to the maximum likelihood state series estimating unit 34.

The feature extracting unit 33 extracts the feature of each frame of the images of the content of interest supplied from the content selecting unit 31, in the same way as with the feature extracting unit 22 illustrated in FIG. 3, and supplies the time series of features of the frames of the content of interest to the maximum likelihood state series estimating unit 34.

The maximum likelihood state series estimating unit 34 uses the cluster information of the model of interest from the model selecting unit 32 to perform clustering of the time series of features of the frames of the content of interest from the feature extracting unit 33, and obtains a code sequence of the features of the content of interest. The maximum likelihood state series estimating unit 34 also uses a Viterbi algorithm, for example, to estimate a maximum likelihood state series which is a state series in which state transition occurs where the likelihood of observation of the code series of features of the content of interest from the feature extracting unit 33 is greatest in the code model of the model of interest from the model selecting unit 32 (i.e., a series of states making up a so-called Viterbi path).

The maximum likelihood state series estimating unit 34 then supplies the maximum likelihood state series where the likelihood of observation of the code series of features of the content of interest is greatest in the code model of the model of interest (hereinafter, also referred to as “code model of interest”) to the dividing unit 15 as a symbol string. Note that hereinafter, this maximum likelihood state series where the likelihood of observation of the code series of features of the content of interest is greatest may also be referred to as “maximum likelihood state series of code model of interest as to content of interest”).

Note that, instead of the maximum likelihood state series of code model of interest as to content of interest, the maximum likelihood state series estimating unit 34 may supply a code series of the content of interest obtained by clustering (a series of cluster IDs) to the dividing unit 15 as a symbol string.

Now, we will say that the state at the point-in-time t with the heard of the maximum likelihood state series of code model of interest as to content of interest (at state making up the maximum likelihood state series that is the t′th state from the head) will be represented by s(t), and the number of frames of the content of interest by T. In this case, the maximum likelihood state series of code model of interest as to content of interest is a series of T states s(1), s(2), and so on through s(T), with the t′th state (state at point-in-time t) s(t) corresponding to the frame at the point-in-time t in the content of interest (frame t).

Also, if we say that the total number of states of the code model of interest is represented by N, the state at point-in-time t s(t) is one of N states s₁, s₂, and so on through s_{N}. Further, each of the N states s₁, s₂, and so on through s_{N} are provided with a state ID (identification) serving as an index identifying the state.

If we say that the state at point-in-time t s(t) in the maximum likelihood state series of code model of interest as to content of interest is the i′th state sᵢ out of the N states s₁ through s_{N}, the frame of the point-in-time t corresponds to the state is. Accordingly, each frame of the content of interest corresponds to one of the N states s₁ through s_{N}.

The maximum likelihood state series of code model of interest as to content of interest actually is a series of state IDs of any of the states s₁ through s_{N} to which each point-in-time t of the content of interest corresponds.

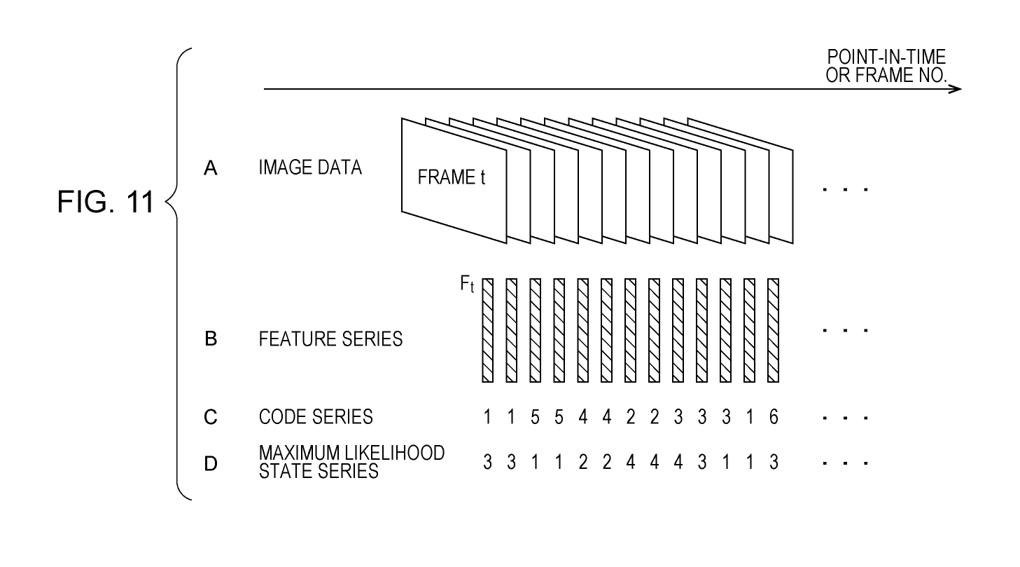

FIG. 11 illustrates an overview of symbol string generating processing which the symbol string generating unit 14 illustrated in FIG. 10 performs. In FIG. 11, A represents the time series of frames of the content selected as the content of interest by the content selecting unit 31. B represents the time series of features of the time series of frames in A. C represents a code series of code obtained by the maximum likelihood state series estimating unit 34 performing clustering of the time series of features of B, and D represents the maximum likelihood state series where the code series of the content of interest in C (more particularly, the code series of the time series of features of the content of interest in C) is observed (the maximum likelihood state series of code model of interest as to content of interest).

In the event of supplying the code series in C to the dividing unit 15, the symbol string generating unit 14 supplies each code (cluster ID) making up the code series to the dividing unit 15 as a symbol. Also, in the event of supplying the maximum likelihood state series in D to the dividing unit 15, the symbol string generating unit 14 supplies each state ID making up the maximum likelihood state series to the dividing unit 15 as a symbol. Description of Operation of Symbol String Generating Unit 14

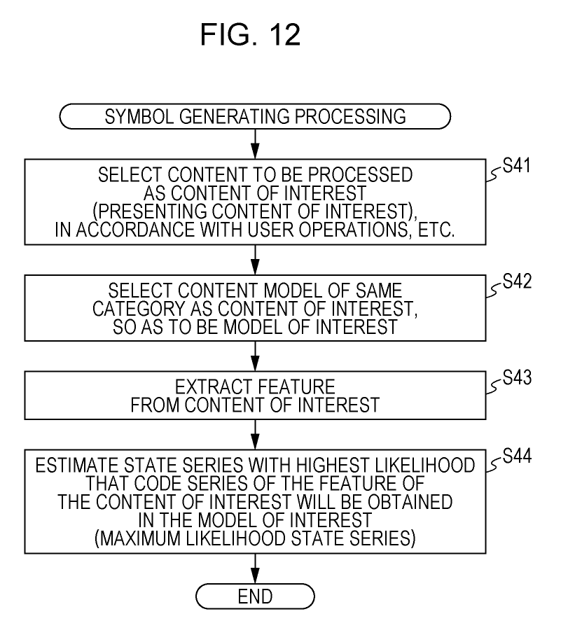

Next, symbol string generating processing which the symbol string generating unit 14 performs will be described with reference to the flowchart in FIG. 12. This symbol string generating processing is started when, for example, a user uses the operating unit 17 to perform a selecting operation to select a content for symbol string generating, from contents stored in the content storage unit 11. At this time, the operating unit 17 supplies operating signals corresponding to the selecting operation performed by the user, to the control unit 16. The control unit 16 controls the content selecting unit 31 based on the operating signal from the operating unit 17.

That is to say, in step S41, the content selecting unit 31 selects a content for which to generate a symbol string, from the contents stored in the content storage unit 11, under control of the control unit 16. The content selecting unit 31 supplies the content of interest to the feature extracting unit 33. The content selecting unit 31 also recognizes the category of the content of interest, and supplies this to the model selecting unit 32.

In step S42, the model selecting unit 32 selects, from the content models stored in the model storage unit 13, a content model of a category matching the category of the content of interest from the content selecting unit 31 (a content model correlated with the category of the content of interest), as the model of interest. The model selecting unit 32 then supplies the model of interest to the maximum likelihood state series estimating unit 34.

In step S43, the feature extracting unit 33 extracts the feature of each frame of the images of the content of interest supplied from the content selecting unit 31, in the same way as with the feature extracting unit 22 illustrated in FIG. 3, and supplies the time series of features of the frames of the content of interest to the maximum likelihood state series estimating unit 34.

In step S44, the maximum likelihood state series estimating unit 34 uses the cluster information of the model of interest from the model selecting unit 32 to perform clustering of the time sequence of features of the content of interest from the feature extracting unit 33, thereby obtaining a code sequence of the features of the content of interest.

The maximum likelihood state series estimating unit 34 further uses a Viterbi algorithm, for example, to estimate a maximum likelihood state series which is a state series in which state transition occurs where the likelihood of observation of the code series of features of the content of interest from the feature extracting unit 33 is greatest in the code model of the model of interest from the model selecting unit 32 (i.e., a series of states making up a so-called Viterbi path). The maximum likelihood state series estimating unit 34 then supplies the maximum likelihood state series where the likelihood of observation of the code series of features of the content of interest is greatest in the code model of the model of interest (hereinafter, also referred to as “code model of interest”), i.e., a maximum likelihood state series of code model of interest as to content of interest, to the dividing unit 15 as a symbol string.

Note that, instead of the maximum likelihood state series of code model of interest as to content of interest, the maximum likelihood state series estimating unit 34 may supply a code series of the content of interest obtained by clustering to the dividing unit 15 as a symbol string. This ends the symbol string generating processing.

Next, FIG. 13 illustrates an example of the dividing unit 15 dividing a content into multiple meaningful segments, based on the symbol string from the symbol string generating unit 14. Note that FIG. 13 is configured in the same way as with FIG. 2. For example, in FIG. 13, the horizontal axis represents points-in-time t, and the vertical axis represents symbols at frames t.

Also illustrated in FIG. 13 are partitioning lines (heavy line segments) for dividing the content into the six segments of s₁, s₂, s₃, s₄, s₅, and s₆. The partitioning lines are situated (drawn) at optional points-in-time t.

Now, in the event that a code series is employed as the symbol string, the symbols are each code making up the code series (the code illustrated in C in FIG. 11). Also, in the event that a maximum likelihood state series is employed as the symbol string, the symbols are each code making up the maximum likelihood state series (the code illustrated in D in FIG. 11).

The dividing unit 15 divides the content by drawing the line segments at boundaries between first partial series and second partial series, at boundaries between two first partial series, and at boundaries between two second partial series, in the same way as described with reference to FIG. 2. Specifically, the dividing unit 15 may draw the partitioning lines such that the summation Q of the entropy H(Sᵢ) of the segments Sᵢ (i=1, 2, . . . 6) illustrated in FIG. 13 is minimal. Note that the entropy of the segments Sᵢ represents the degree of dispersion of symbols in the segments Sᵢ.

Note that when a partitioning line is situated at an optional point-in-time t, the content is divided with the frame t as a boundary. That is to say, when a partitioning line is situated at an optional point-in-time t in a content that has not yet been divided, the content is divided into a segment including from the head frame 0 through frame t−1, and a segment including from frame t through the last frame T.

The dividing unit 15 calculates dividing positions at this to divide the content (positions where the partitioning lines should be drawn), based on the dispersion of the symbols in the symbol string from the symbol string generating unit 14 such as illustrated in FIG. 13. The dividing unit 15 then reads out, from the content storage unit 11, the content corresponding to the symbol string from the symbol string generating unit 14, and divides the content into multiple segments at the calculated dividing positions.

For example, let us say that the dividing unit 15 is to divide a content into D segments Sᵢ (i=1, 2, . . . D), D being the total number of divisions specified by upper specifying operations using the operating unit 17. Specifically, the dividing unit 15 calculates the entropy H(Sᵢ) for each segment Sᵢ according to the following Expression (1), for example.

$$H ( Si ) = - {\sum }_{k} {P}^{[ Si ]} ( k ) \times log \{ {P}^{[ Si ]} ( k ) \} \qquad ( 1 )$$

where probability P^{[Si]}(k) represents the probability of a k′th symbol (a symbol with the k′th smallest value) when the symbols in the segment Sᵢ are arrayed in ascending order, for example. In Expression (1), P^{[Si]}(k) equals the frequency count of the k′th symbol within the segment Sᵢ, divided by the total number of symbols within the segment Sᵢ.

The dividing unit 15 also calculates the summation Q of entropy H(S₁) through H(S_{D}) for all segments S₁ through S_{D}, using the following Expression (2).

$$Q = {\sum }_{i} \{ H ( Si ) \} \qquad ( 2 )$$

The segments S₁, S₂, S₃, S₄, S₅, S₆, and so on through S_{D}, which minimize the summation Q are the segments S₁, S₂, S₃, S₄, S₅, S₆, and so on through S_{D}, divided by the partitioning lines illustrated in FIG. 13. Accordingly, by solving the minimization problem whereby the calculated summation Q is minimized, the dividing unit 15 divides the content into multiple segments S₁ through S_{D}, and supplies the content after dividing, to the content storage unit 11.

Examples of ways to solve the minimization problem of the summation Q include recursive bisection processing and annealing partitioning processing. However, ways to solve the minimization problem of the summation Q are not restricted to these, and the minimization problem may be solved using tabu search, genetic algorithm, or the like.

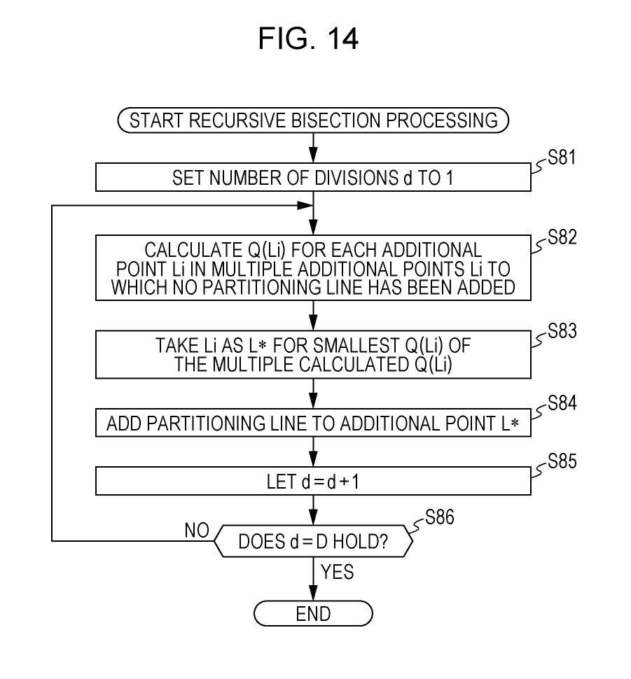

Recursive bisection processing is processing where a content is divided into multiple segments by recursively (repeatedly) dividing the content at a division position where the summation of entropy of the segments following division is the smallest. Recursive bisection processing will be described in detail with reference to FIG. 14.

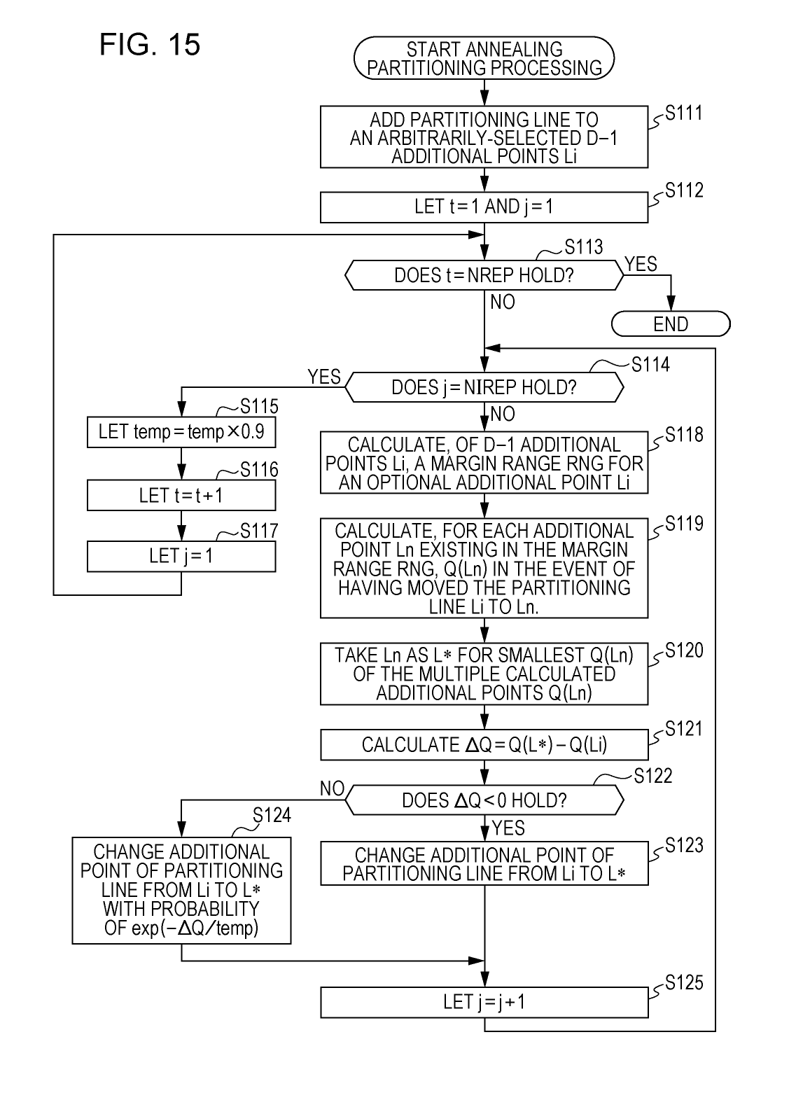

Also, annealing partitioning processing is processing where a content is divided into multiple segments by performing processing where the dividing position of having dividing a content arbitrarily is changed to a division position where the summation of entropy of the segments following division is the smallest. Annealing partitioning processing will be described in detail with reference to FIG. 15.

### Description of Operation of Dividing Unit 15

Next, the recursive bisection processing which the dividing unit 15 performs will be described with reference to the flowchart in FIG. 14. This recursive bisection processing is started when, for example, the user uses the operating unit 17 to instruct the dividing unit 15 to divide the symbol string into the total division number D specified by the user.

At this time, the operating unit 17 supplies an operating signal corresponding to the user specifying operations to the control unit 16. The control unit 16 controls the dividing unit 15 in accordance with the operating signal from the operating unit 17, such that the dividing unit 15 divides the symbol string into the total number of divisions D specified by the user.

In step S81, the dividing unit 15 sets the number of divisions d held beforehand in unshown internal memory to 1. The number of divisions d represents the number of divisions of having divided the symbol string by the recursive bisection processing. When the number of divisions d=1, this means that the symbol string has not yet been divided.

In step S82, out of additional points Li to which a partitioning line can be added, the dividing unit 15 calculates entropy summation Q=Q(Li) for each additional point Li to which no partitioning line has been added for when a partitioning line is added thereto, based on the dispersion of the symbols in the symbol string from the symbol string generating unit 14. Note that an additional point Li is a point-in-time t corresponding to frames 1 through T out of the frames 0 through T making up the content.

In step S83, of the entropy summation Q(Li) calculated in step S82, the dividing unit 15 takes the Li with the smallest summation Q=Q(Li) as L*.

In step S84, the dividing unit 15 adds a partitioning line at the additional point L*, and in step S85 increments the number of divisions d by 1. This means that the dividing unit 15 has divided the symbol string from the symbol string generating unit 14 at the additional point L*.

In step S86, the dividing unit 15 determines whether or not the number of divisions d is equal to the total number of divisions D specified by user specifying operations, and in the event that the number of divisions d is not equal to the total number of divisions D, the flow returns to step S82 and the same processing is subsequently repeated.

On the other hand, in the event that determination is made that the number of divisions d is equal to the total number of divisions D, that is to say in the event that determination is made that the symbol string has been divided into D segments S₁ through S_{D}, the dividing unit 15 ends the recursive bisection processing. The dividing unit 15 then reads out, from the content storage unit 11, the same content as the content converted into the symbol string at the symbol string generating unit 14, and divides the content that has been read out at the same division positions as the division positions at which the symbol string has been divided. The dividing unit 15 supplies the content divided into the multiple segments S₁ through S_{D}, to the content storage unit 11, so as to be stored.

As described above, with the recursive bisection processing illustrated in FIG. 14, a content is divided into D segments S₁ through S_{D} whereby the summation Q of entropy H(Sᵢ) is minimized. Accordingly, with the recursive bisection processing illustrated in FIG. 14, the content can be divided into meaningful segments in the same way as with the subjects in the experiment. That is to say, a content can be divided into, for example, sections of a broadcast program, individual news topics, and so forth, as multiple segments.

Also, with the recursive bisection processing illustrated in FIG. 14, the content can be divided with a relatively simple algorithm. Accordingly, a content can be speedily divided with relatively few calculations with recursive bisection processing.

### Another Description of Operation of Dividing Unit 15

Next, the annealing partitioning processing which the dividing unit 15 performs will be described with reference to the flowchart in FIG. 15. This annealing partitioning processing is started when, for example, the user uses the operating unit 17 to instruct the dividing unit 15 to divide the symbol string into the total division number D specified by the user.

At this time, the operating unit 17 supplies an operating signal corresponding to the user specifying operations to the control unit 16. The control unit 16 controls the dividing unit 15 in accordance with the operating signal from the operating unit 17, such that the dividing unit 15 divides the symbol string into the total number of divisions D specified by the user.

In step S111, the dividing unit 15 selects, of additional points Li representing points-in-time at which a partitioning line can be added, D−1 arbitrary additional points Li, and adds (situates) partitioning lines at the selected D−1 additional points Li. Thus, the dividing unit 15 has tentatively divided the symbol string from the symbol string generating unit 14 into D segments S₁ through S_{D}.

In step S112, the dividing unit 15 sets variables t and j, held beforehand in unshown internal memory, each to 1. Also, the dividing unit 15 sets (initializes) a temperature parameter temp held beforehand in unshown internal memory to a predetermined value.

In step S113, the dividing unit 15 determines whether or not the variable t is on a predetermined threshold value NREP or not, and in the event that determination is made that the variable t is not on the predetermined threshold value NREP, the flow advances to step S114.

In step S114, the dividing unit 15 determines whether or not the variable j is on a predetermined threshold value NIREP or not, and in the event that determination is made that the variable j is on the predetermined threshold value NIREP, the flow advances to step S115. Note that the threshold value NIREP is preferably a value sufficiently greater than the threshold value NREP.

In step S115, the dividing unit 15 replaces the temperature parameter temp held beforehand in unshown internal memory with a multiplication result temp×0.9 which is obtained by multiplying by 0.9, to serve as a new temp after changing.

In step S116, the dividing unit 15 increments the variable t by 1, and in step S117 sets the variable j to 1. Thereafter, the flow returns to step S113, and the dividing unit 15 subsequently performs the same processing.

In step S114, in the event that the dividing unit 15 has determined that the variable j is not on the threshold value NIREP, the flow advances to step S118.

In step S118, the dividing unit 15 determines out of the D−1 additional points regarding which partitioning lines have already been added, an arbitrary additional point Li, and calculates a margin range RNG for the decided additional point Li. Note that a margin range RNG represents a range from Li−x to Li+x regarding the additional point Li. Note that x is a positive integer, and has been set beforehand at the dividing unit 15.

In step S119, the dividing unit 15 calculates Q(Ln) for when the additional point Li decided in step S118 is moved to an additional point Ln (where n is a positive integer within the range of i−x to i+x) included in the margin range RNG also calculated in step S118.

In step S120, the dividing unit 15 decides, of the multiple Q(Ln) calculated in step S119, Ln of which Q(Ln) becomes the smallest, to be L*, and calculates Q(L*). The dividing unit 15 also calculates Q(Li) before moving the partitioning line.

In step S121, the dividing unit 15 calculates a difference ΔQ=Q(L*)−Q(Li) obtained by subtracting the Q(Li) before moving the partitioning line from the Q(L*) after moving the partitioning line.

In step S122, the dividing unit 15 determines whether or not the difference ΔQ calculated in step S121 is smaller than 0. In the event that determination is made that the difference Δ is smaller than 0, the flow advances to step S123.

In step S123, the dividing unit 15 moves the partitioning line set at the additional point Li decided in step S118 to the additional point L* decided in step S120, and advances the flow to step S125.

On the other hand, in the event that determination is made in step S122 that the difference Δ is smaller than 0, the dividing unit 15 advances the flow to step S124.

In step S124, the dividing unit 15 moves the additional point Li decided in step S118 to the additional point L* decided in step S120, with a probability of exp(ΔQ/temp), which is the natural logarithm base e to the ΔQ/temp power. The flow then advances to step S125.

In step S125, the dividing unit 15 increments the variable j by 1, returns the flow to step S114, and subsequently performs the same processing.

Note that in the event that determination is made in step S113 that the variable t is on the predetermined threshold value NREP, the annealing partitioning processing of FIG. 15 ends.

The dividing unit 15 then reads out the, from the content storage unit 11, the same content as the content converted into the symbol string at the symbol string generating unit 14, and divides the content that has been read out at the same division positions as the division positions at which the symbol string has been divided. The dividing unit 15 supplies the content divided into the multiple segments S₁ through S_{D}, to the content storage unit 11, so as to be stored. Thus, with the annealing partitioning processing illustrated in FIG. 15, the content can be divided into meaningful segments in the same way as with the recursive bisection processing in FIG. 14.

While description has been made above with the dividing unit 15 dividing the content read out from the content storage unit 11 into the total number of divisions D specified by user instructing operations, other arrangements may be made, such as the dividing unit 15 dividing the content by, out of total division numbers into which the content can be divided, a total number of divisions D whereby the summation Q of entropy is minimized.

Alternatively, an arrangement may be made where, in the event that the user has instructed a total number of divisions D by user instructing operations, the dividing unit 15 divides the content into the total number of divisions D, but in the event no total number of divisions D has been instructed, the dividing unit 15 divides the content by the total number of divisions D whereby the summation Q of entropy is minimized.

### Description of Operation of Recorder 1

Next, description will be made regarding content dividing processing where, in the event that the user has instructed a total number of divisions D by user instructing operations, the recorder 1 divides the content into the total number of divisions D, and in the event no total number of divisions D has been instructed, divides the content by the total number of divisions D whereby the summation Q of entropy is minimized.

In step S151, the content model learning unit 12 performs the content model learning processing described with reference to FIG. 9.

In step S152, the symbol string generating unit 14 performs the symbol string generating processing described with reference to FIG. 12.

In step S153, the control unit 16 determines whether or not a total number of divisions D has been instructed by user instruction operation, within a predetermined period, based on operating signals from the operating unit 17. In the event that determination is made that a total number of divisions D has been instructed by user instruction operation, based on operating signals from the operating unit 17, the control unit 16 controls the dividing unit 15 such that the dividing unit 15 divides the content by the total number of divisions D instructed by user instruction operation.

For example, the dividing unit 15 divides the content at dividing positions obtained by the recursive bisection processing in FIG. 14 or the annealing partitioning processing in FIG. 15 (i.e., at positions where partitioning lines are situated). The dividing unit 15 then supplies the content divided into the total number of divisions D segments to the content storage unit 11 to be stored.

On the other hand, in Step S153 in the event that determination is made that a total number of divisions D has not been instructed by user instruction operation, based on operating signals from the operating unit 17, the control unit 16 advances the flow to step S155. In the processing of step S155 and subsequent steps, the control unit 16 controls the dividing unit 15 such that, out of total division numbers into which the content can be divided, a total number of divisions D is calculated whereby the summation Q of entropy is minimized, and the content to be divided is divided by the calculated total number of divisions D.

In step S155, the dividing unit 15 uses one or the other of recursive bisection processing and annealing partitioning processing, for example, to calculate the entropy summation Q_{D} of when the symbol string is divided with a predetermined total number of divisions D (e.g., D=2).

In step S156, the dividing unit 15 calculates the mean entropy mean(Q_{D})=Q_{D}/D based on the calculated entropy summation Q_{D}.

In step S157, the dividing unit 15 uses the same dividing processing as with step S155 to calculate the entropy summation Q_{D+1} of when the symbol string is divided with a total number of divisions D+1.

In step S158, the dividing unit 15 calculates the mean entropy mean(Q_{D+1})=Q_{D+1}/(D+1) based on the calculated entropy summation Q_{D+1}.

In step S159, the dividing unit 15 calculates a difference Δmean obtained by subtracting the mean entropy mean(Q_{D}) calculated in step S156 from the mean entropy mean(Q_{D+1}) calculated in step S158.

In step S160, the dividing unit 15 determines whether or not the difference Δmean is smaller than a predetermined threshold value TH, and in the event that the difference Δmean is not smaller than the predetermined threshold value TH (i.e., equal to or greater), the flow advances to step S161.

In step S161, the dividing unit 15 increments the predetermined total number of divisions D by 1, takes D+1 as the new total number of divisions D, returns the flow to step S157, and subsequently performs the same processing.

In step S160, in the event that determination is made that the difference Δmean calculated in step S159 is smaller than the threshold TH, the dividing unit 15 concludes that the entropy summation Q when dividing the symbol string by the predetermined total number of divisions D is smallest, and advances the flow to step S162.

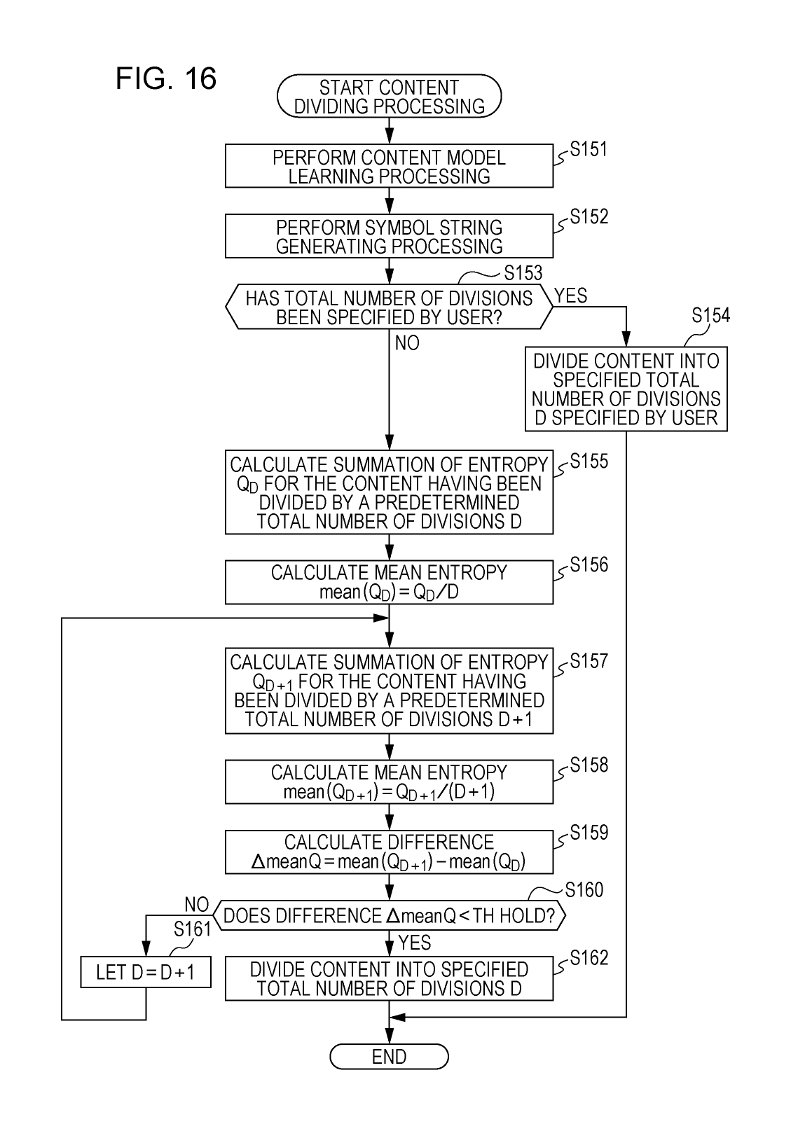

In step S162, the dividing unit 15 divides the content at the same division positions as the division positions at which the symbol string has been divided, and supplies the content divided into the predetermined total number of divisions D, to the content storage unit 11, so as to be stored. Thus, the content dividing processing in FIG. 16 ends.

Thus, with the content dividing processing in FIG. 16, in the event that the user has instructed a total number of divisions D by user instructing operations, the content is divided into the specified total number of divisions D. Accordingly, the content can be divided into the total number of divisions D which the user has instructed. On the other hand, in the event no total number of divisions D has been instructed by user instruction operations, the content is divided by the total number of divisions D whereby the summation Q of entropy is minimized. Thus, the user can be spared the trouble of specifying the total number of divisions D at the time of dividing the content.

With the first embodiment, description has been made with the recorder 1 dividing the content into multiple meaningful segments. Accordingly, the user of the recorder 1 can select a desired segment (e.g., a predetermined section of a broadcasting program), from multiple meaningful segments. While description has been made of the recorder 1 dividing a content into multiple segments, the object of division is not restricted to content, and may be, for example, audio data, waveforms such as brainwaves, and so forth. That is to say, the object of division may be any sort of data, as long as it is time-sequence data where data is arrayed in a time sequence.

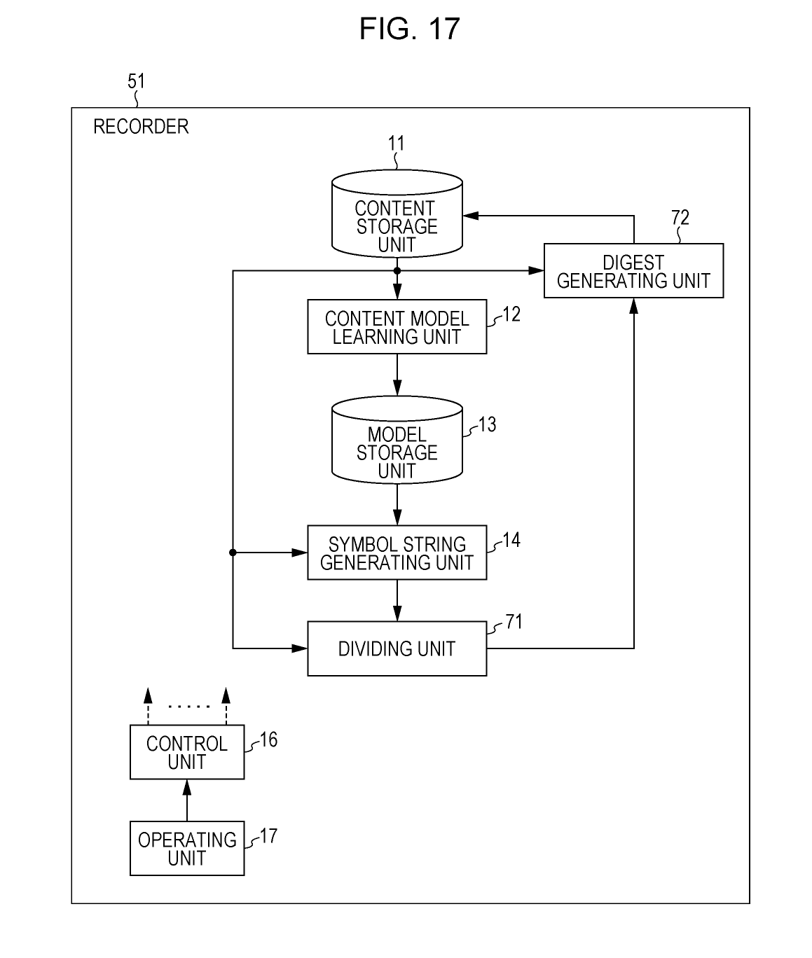

Now, if a digest (summary) is generated for each segment, the user can select and play desired segments more easily be referring to the generated digest. Accordingly, in addition to dividing the content into multiple meaningful segments, it is preferable to generate a digest for each of the multiple segments. Such a recorder 51 which generates a digest for each of the multiple segments in addition to dividing the content into multiple meaningful segments will be described with reference to FIGS. 17 through 25.

### 2. Second Embodiment

### Configuration Example of Recorder 51

FIG. 17 illustrates a configuration example of the recorder 51, which is a second embodiment. Portions of the recorder 51 illustrated in FIG. 17 which are configured the same as with the recorder 1 according to the first embodiment illustrated in FIG. 1 are denoted with the same reference numerals, and description thereof will be omitted as appropriate. The recorder 51 is configured in the same way as the recorder 1 except for a dividing unit 71 being provided instead of the dividing unit 15 illustrated in FIG. 1, and a digest generating unit 72 being newly provided.

The dividing unit 71 performs the same processing as with the dividing unit 15 illustrated in FIG. 1. The dividing unit 71 then supplies the content after division into multiple segments to the content storage unit 11 via the digest generating unit 72, so as to be stored. The dividing unit 71 also generates chapter IDs for uniquely identifying the head frame of each segment (the frame t of the point-in-time t where a partitioning line has been situated) when dividing the content into multiple segments, and supplies these to the digest generating unit 72. In the following description, segments obtained by the dividing unit 71 dividing a content will also be referred to as “chapters”.

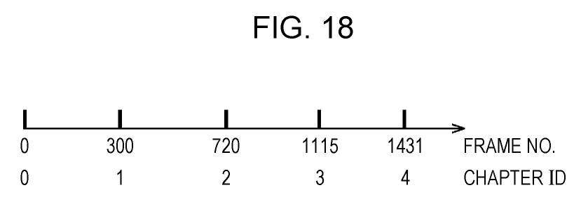

Next, FIG. 18 illustrates an example of chapter point data generated by the dividing unit 71. Illustrated in FIG. 18 is an example of partitioning lines being situated at the points-in-time of frames corresponding to frame Nos. 300, 720, 1115, and 1431, out of the multiple frames making up a content. More specifically, illustrated here is an example of a content having been divided into a chapter (segment) made up of frame Nos. 0 through 299, a chapter made up of frame Nos. 300 through 719, a chapter made up of frame Nos. 720 through 1114, a chapter made up of frame Nos. 1115 through 1430, and so on.

Here, frame No. t is a number of uniquely identifying a frame t the t′th from the head of the content. A chapter ID correlates to the heard frame (the frame with the smallest frame No.) of the frames making up a chapter. That is to say, chapter ID “0” is correlated with frame 0 of frame No. 0, and chapter ID “1” is correlated with frame 300 of frame No. 300. In the same way, chapter ID “2” is correlated with frame 720 of frame No. 720, chapter ID “3” is correlated with frame 1115 of frame No. 1115, and chapter ID “4” is correlated with frame 1431 of frame No. 1431.

The dividing unit 71 supplies the multiple chapter IDs such as illustrated in FIG. 18 to the digest generating unit 72 illustrated in FIG. 17, as chapter point data.

Returning to FIG. 17, the digest generating unit 72 reads out, from the content storage unit 11, the same content as the content which the dividing unit 71 has read out. Also, based on the chapter point data from the dividing unit 71, the digest generating unit 72 identifies each chapter of the content read out from the content storage unit 11.

The digest generating unit 72 then extracts chapter segments of a predetermined length (basic segment length) from each identified chapter. That is to say, the digest generating unit 72 extracts, from each identified chapter, a portion representative of the chapter, such as a predetermined portion of a basic segment length from the head of the chapter over a basic segment length, for example. Note that the basic segment length may be a range from 5 to 10 seconds, for example. Also, the user may change the basic segment length by changing operations using the operating unit 17.

Further, the digest generating unit 72 extracts feature time sequence data from the content that has been read out, and extracts feature peak segments from each chapter, based on the extracted feature time sequence data. A feature peak segment is a feature portion of the basic segment length. Note that feature time sequence data represents the features of the time sequence used at the time of extracting the feature peak segment. Detailed description of feature time sequence data will be made later.

The digest generating unit 72 may extract feature peak segments with different lengths from chapter segments. That is to say, the basic segment length of chapter segments and the basic segment length of feature peak segments may be different lengths.

Further, the digest generating unit 72 may extract one feature peak segment from one chapter, or may extract multiple feature peak segments from one chapter. Moreover, the digest generating unit 72 does not have to typically extract a feature peak segment from every chapter.

The digest generating unit 72 arrays the chapter segments and feature peak segments extracted from each chapter in time sequence, thereby generating a digest representing a general overview of the content, and supplies this to the content storage unit 11 to be stored. In the event that marked scene switching is occurring within a period to be extracted as a chapter segment, the digest generating unit 72 may extract a portion thereof, up to immediately before a scene switch, as a chapter segment. This enables the digest generating unit 72 to extract chapter segments divided at suitable breaking points. This is the same for feature peak segments, as well.

Note that the digest generating unit 72 may determine whether or not marked scene switching is occurring, based on whether or not the sum of absolute differences for pixels of temporally adjacent frames is at or greater than a predetermined threshold value, for example.

Also, the digest generating unit 72 may detect speech sections where speech is being performed in a chapter, based on identified audio data of that chapter. In the event that the speech is continuing even after the period for extracting as a chapter segment has elapsed, the digest generating unit 72 may extract up to the end of the speech as a chapter segment. This is the same for feature peak segments, as well.

Also, in the event that at a speech segment is sufficiently longer than the basic segment length, for example, in the event that the speech section is twice as long the basic segment length or longer, the digest generating unit 72 may extract a chapter segment cut off partway through the speech. This is the same for feature peak segments, as well.

In such a case, an effect is preferably added to the chapter segment such that the user does not feel that the chapter segment being cut off partway through the speech seems unnatural. That is to say, the digest generating unit 72 preferably applies an effect where the speech in the extracted chapter segment fades out toward the end of the chapter segment (the volume gradually diminishes), or the like.

Now, the digest generating unit 72 extracts chapter segments and feature peak segments from the content divided by the dividing unit 71. However, if the user uses editing software or the like to divide the content into multiple chapters, for example, the user can extract chapter segments and peak segments from the content. Note that chapter point data is generated by the editing software or the like when dividing the content into multiple chapters. Description will be made below with an arrangement where the digest generating unit 72 extracts one each of a chapter segment and feature peak segment from each chapter, and adds only background music (hereinafter, also abbreviated to “BGM”) to the generated digest.

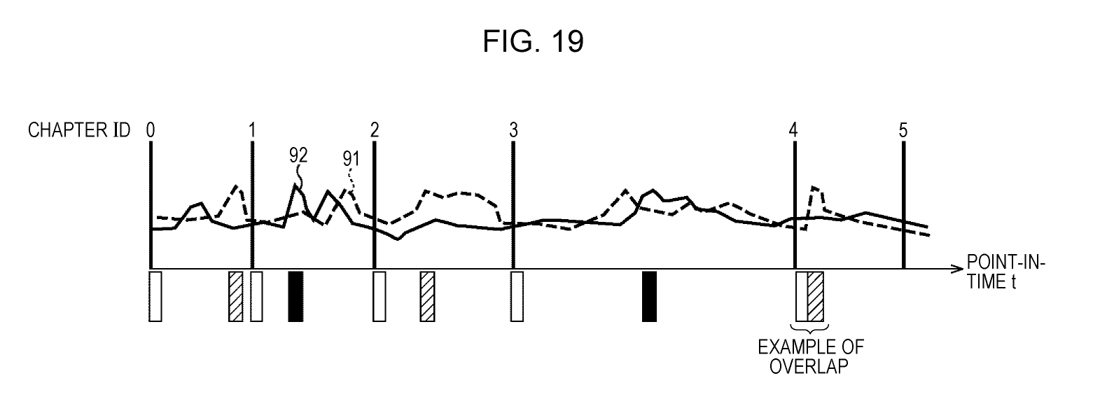

Next, FIG. 19 illustrates an overview of digest generating processing which the digest generating unit 72 performs. Illustrated in FIG. 19 are partitioning lines dividing the content regarding which the digest is to be extracted, into multiple chapters. Corresponding chapter IDs are shown above the partitioning lines. Also illustrated in FIG. 19 are audio power time-series data 91 and facial region time-series data 92.

Here, audio power time-series data 91 refers to time-series data which exhibits a greater value the greater the audio of the frame t is. Also, facial region time-series data 92 refers to time-series data which exhibits a greater value the greater the ratio of facial region displayed in the frame t is.

Note that is FIG. 19, the horizontal axis represents the point-in-time t at the time of playing the content, and the vertical axis represents feature time-series data. Further, in FIG. 19, the white rectangles represent chapter segments indicating the head portion of chapters, and the hatched rectangles represent feature peak segments extracted based on the audio power time-series data 91. Also, the solid rectangles represent feature peak segments extracted based on the facial region time-series data 92.

Based on the chapter point data from the dividing unit 71, the digest generating unit 72 identifies the chapters read out from the content storage unit 11, and extracts chapter segments of the identified chapters.

Also, the digest generating unit 72 extracts audio power time-series data 91 such as illustrated in FIG. 19, for example, from the content read out from the content storage unit 11. Further, the digest generating unit 72 extracts a frame from each identified chapter where the audio power time-series data 91 is the greatest. The digest generating unit 72 then extracts a feature peak segment including the extracted peak feature frame (e.g., a feature peak segment of which the peak feature frame is the head), from the chapter.

Also, the digest generating unit 72 may, for example, decide extracting points of peak feature frames, at set intervals. The digest generating unit 72 then may extract a frame where the audio power time-series data 91 is the greatest within the range decided based on the decided extracting point, as the peak feature frame.

Also, an arrangement may be made wherein, in the event that the maximum value of the audio power time-series data 91 does not exceed a predetermined threshold value, the digest generating unit 72 does not extract a peak feature frame. In this case, the digest generating unit 72 does not extract a feature peak segment.

Further, an arrangement may be made wherein the digest generating unit 72 extracts a frame where the audio power time-series data 91 is maximum as the peak feature frame, instead of the greatest value of the audio power time-series data 91.

Also note that besides extracting a feature peak segment using one audio power time-series data 91, the digest generating unit 72 may extract a feature peak segment using multiple sets of feature time-series data to extract a feature peak segment. That is to say, for example, the digest generating unit 72 extracts facial region time-series data 92 from the content read out from the content storage unit 11, besides the audio power time-series data 91. Also, the digest generating unit 72 selects, of the audio power time-series data 91 and facial region time-series data 92, the feature time-series data of which the greatest value in the chapter is greatest. The digest generating unit 72 then extracts the frame at which the selected feature time-series data is the greatest value in the chapter, as a peak feature frame, and extracts a feature peak segment including the extracted peak feature frame, from the chapter.

In this case, the digest generating unit 72 selects a portion where the volume is great in a predetermined chapter, as a feature peak segment, and in other chapters, extracts portions where the facial region ratio is greater as feature peak segments. Accordingly, the digest generating unit 72 selecting just a portion where the volume is great as a feature peak segment, for example, prevents a monotonous digest from being generated. That is to say, the digest generating unit 72 can generate a digest with more of an atmosphere of feature peak segments having been selected randomly. Accordingly, the digest generating unit 72 can generate a digest that prevents users from becoming bored with an unchanging pattern.

Alternatively, the digest generating unit 72 may extract a peak segment for each plurality of feature time-series data, for example. That is to say, with this arrangement for example, the digest generating unit 72 extracts a feature peak segment including a frame, where the audio power time-series data 91 becomes the greatest value in each identified chapter, as a peak feature frame. Also, the digest generating unit 72 extracts a feature peak segment including a frame, where the facial region time-series data 92 becomes the greatest value, as a peak feature frame. In this case, the digest generating unit 72 extracts two feature peak segments from one chapter.

Note that, as illustrated to the lower right in FIG. 19, a chapter segment (indicated by white rectangle) and a feature peak segment (indicated by hatched rectangle) are extracted in an overlapping manner from the chapter starting at the partitioning line corresponding to chapter ID 4 through the partitioning line corresponding to chapter ID 5. In this case, the digest generating unit 72 handles the chapter segment and feature peak segment as a single segment.

The digest generating unit 72 connects the chapter segments and peak segments extracted as illustrated in FIG. 19, for example, in time sequence, thereby generating a digest. The digest generating unit 72 then includes BGM or the like in the generated digest, and supplies the digest with BGM added thereto to the content storage unit 11 so as to be stored.

### Details of Digest Generating Unit 72

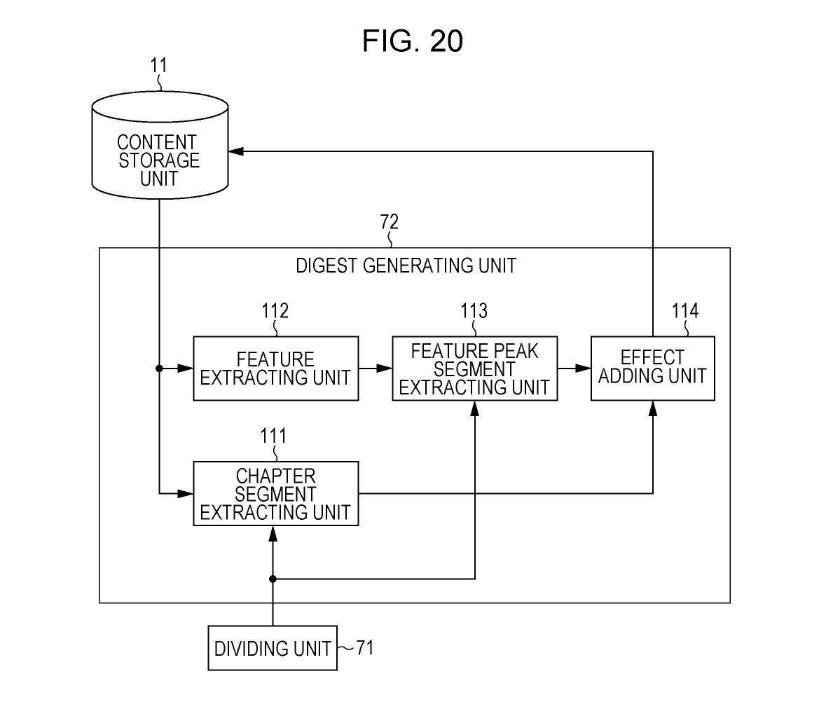

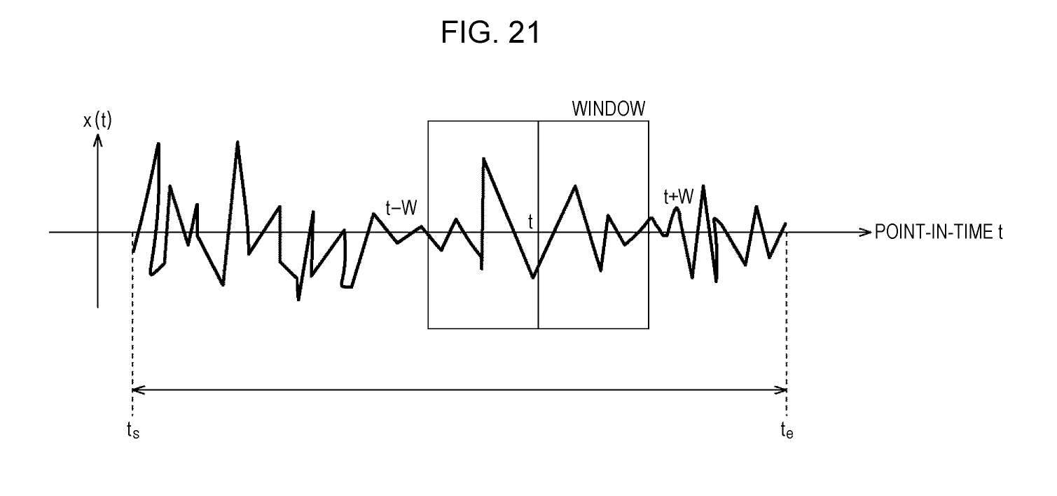

FIG. 20 illustrates a detailed configuration example of the digest generating unit 72. The digest generating unit 72 includes a chapter segment extracting unit 111, a feature extracting unit 112, a feature peak segment extracting unit 113, and an effect adding unit 114.

The chapter segment extracting unit 111 and feature extracting unit 112 are supplied with a content from the content storage unit 11. Also, the chapter segment extracting unit 111 and feature peak segment extracting unit 113 are supplied with chapter point data from the dividing unit 71.

The chapter segment extracting unit 111 identifies each chapter in the content supplied from the content storage unit 11, based on the chapter point data from the dividing unit 71. The chapter segment extracting unit 111 then extracts chapter segments from the identified chapters, and supplies these to the effect adding unit 114.

The feature extracting unit 112 extracts multiple sets of feature time-series data, for example, from the content supplied from the content storage unit 11, and supplies this to the feature peak segment extracting unit 113. Note that feature time-series data will be described in detail with reference to FIGS. 21 through 23. The feature extracting unit 112 may smooth the extracted feature time-series data using a smoothing filter, and supply the feature peak segment extracting unit 113 with the feature time-series data from which noise has been removed. The feature extracting unit 112 further supplies the feature peak segment extracting unit 113 with the content from the content storage unit 11 without any change.

The feature peak segment extracting unit 113 identifies each chapter of the content supplied from the content storage unit 11 via the feature extracting unit 112, based on the chapter point data from the dividing unit 71. The feature peak segment extracting unit 113 also extracts a feature peak segment from each identified chapter, as described with reference to FIG. 19, based on the multiple sets of feature time-series data supplied from the feature extracting unit 112, and supplies to the effect adding unit 114.

The effect adding unit 114 connects the chapter segments and peak segments extracted as illustrated in FIG. 19, for example, in time sequence, thereby generating a digest. The effect adding unit 114 then includes BGM or the like in the generated digest, and supplies the digest with BGM added thereto to the content storage unit 11 so as to be stored. The processing of the effect adding unit 114 adding BGM or the like to the digest will be described in detail with reference to FIG. 24. Moreover, the effect adding unit 114 may add effects such as fading out frames close to the end of each segment making up the generated digest (chapter segments and feature peak segments), fading in frames immediately after starting, and so forth.

### Example of Feature Time-Series Data

Next, the method by which the feature extracting unit 112 illustrated in FIG. 20 extracts (generates) feature time-series data from the content will be described. Note that the feature extracting unit 112 extracts, from the content, at least one of facial region time-series data, audio power time-series data, zoom-in intensity time-series data, and zoom-out time-series data, as feature time-series data.

Here, the facial region time-series data is used at the time of the feature peak segment extracting unit 113 extracting a segment including frames where the ratio of facial regions in frames has become great, from the chapter as a feature peak segment.

The feature extracting unit 112 detects a facial region, or more particularly, the number of pixels thereof, which is a region where a human face exists. Based on the detected results, the feature extracting unit 112 calculates a facial region feature value f₁(t)=Rₜ−ave(Rₜ′) for each frame t, thereby generating facial region time-series data obtained by arraying facial region feature values f₁(t) in the time series of frame t.

Note that the ratio is the number of pixels in the facial region divided by the total number of pixels of the frame, and ave(Rₜ′) represents the average of the ratio Rₜ obtained from frame t′ existing in section [t−W_{L}, t+W_{L}]. Also, the point-in-time t represents the point-in-time t at which the frame t is displayed, and value W_{L}(>0) is a preset value.

Next, FIG. 21 illustrates an example of the feature extracting unit 112 generating audio power time-series data as feature time-series data. In FIG. 21, audio data x(t) represents audio data played in all sections [tₛ, tₑ] from point-in-time tₛ to point-in-time tₑ.

Now, audio power time-series data is used at the time of the feature peak segment extracting unit 113 extracting a segment including a frame where the audio (volume) has become great, from the chapter as a feature peak segment.

The feature extracting unit 112 calculates the audio power P(t) of each frame t making up the content, by the following Expression (3).

$$P ( t ) = \sqrt{{\sum }_{τ = t - w}^{t + w} \times {( τ )}^{2}} \qquad ( 3 )$$

where audio power P(t) represents the square root of the sum of squares of each audio data x(τ). Also, τ is a value from t−W to t+W, with W having been set beforehand.

The feature extracting unit 112 calculates the difference value obtained by subtracting the average value of audio power P(t) calculated from all sections [tₛ, tₑ], from the average value of audio power P(t) calculated from section [t−W, t+W], as the audio power feature value f₂(t). By calculating the audio power feature value f₂(t) for each frame t, the feature extracting unit 112 generates audio power time-series data obtained by arraying the audio power feature value f₂(t) in time sequence of frame t.

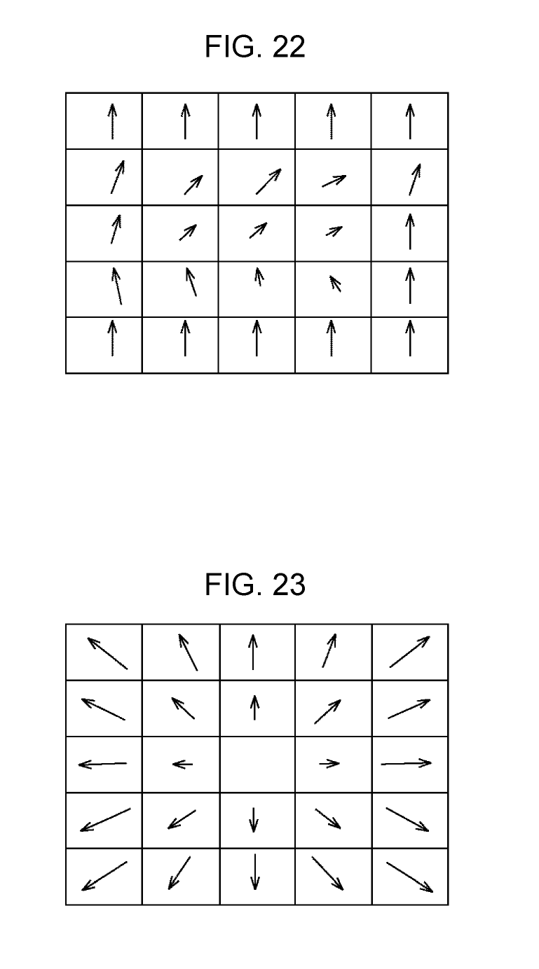

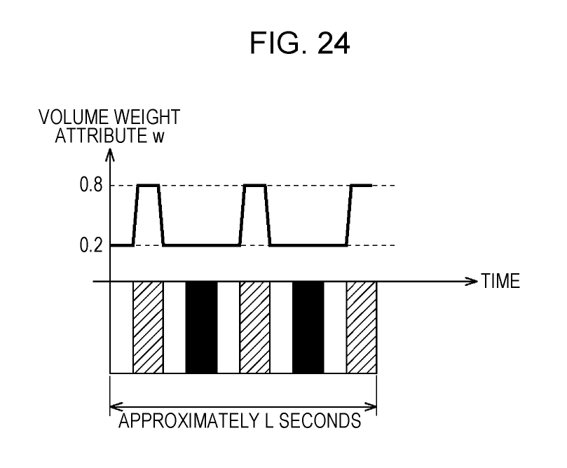

Next, a method by which the feature extracting unit 112 generates zoom-in intensity time-series data as feature time-series data will be described with reference to FIGS. 22 and 23. Note that zoom-in intensity time-series data is used at the time of the feature peak segment extracting unit 113 extracting a segment including zoom-in (zoom-up) frames, from the chapter as a feature peak segment.

FIG. 22 illustrates an example of motion vectors in a frame t. In FIG. 22, the frame t has been sectioned into multiple blocks. A motion vector of each block in the frame t is shown therein.

The feature extracting unit 112 sections each frame t making up the content in to multiple blocks such as illustrated in FIG. 22. The feature extracting unit 112 then uses each frame t making up the content to detect vectors of each of the multiple blocks, by block matching or the like. Note that “motion vectors of the blocks in frame t” means vectors representing motion of blocks in, for example, frame t to frame t+1.

FIG. 23 illustrates an example of a zoom-in template configured of motion vectors of which the inner products with the blocks in frame t have been calculated. This zoom-in template is configured of motion vectors representing the motion of the blocks zoomed in, as illustrated in FIG. 23.

The feature extracting unit 112 calculates the inner product aₜ·b of the motion vectors aₜ of the blocks in frame t (FIG. 22) and the corresponding motion vectors b of the blocks of the zoom-in template (FIG. 23), and calculates the summation sum(aₜ·b) thereof. The feature extracting unit 112 also calculates the average ave(sum(aₜ·b)) of the summation sum(aₜ·b) calculated for each frame t′ included in the section [t−W, t+W].

The feature extracting unit 112 then calculates the difference obtained by subtracting the average ave(sum(aₜ·b)) from the summation sum(aₜ·b), as the zoom-in feature value f₃(t) at frame t. The zoom-in feature value f₃(t) is proportionate to the magnitude of the zoom-in at frame t.

The feature extracting unit 112 calculates the zoom-in feature value f₃(t) for each frame t, and generates zoom-in intensity time-series data obtained by arraying the zoom-in feature value f₃(t) at the time series of frame t.

Now, zoom-out intensity time-series data is used at the time of the feature peak segment extracting unit 113 extracting a segment including zoom-out frames, from the chapter as a feature peak segment. When generating zoom-out intensity time-series data, the feature extracting unit 112 uses, instead of the zoom-in template illustrated in FIG. 23, a zoom-out template which has opposite motion vectors to those illustrated in the template in FIG. 23. That is to say, the feature extracting unit 112 generates zoom-out intensity time-series data using the zoom-out template, in the same way as with generating zoom-in intensity time-series data.

Next, FIG. 24 illustrates details of the effect adding unit 114 adding BGM to the generated digest. The weighting of the volume of the chapter segment feature peak segment of each segment making up the digest is illustrated above in FIG. 24, and a digest obtained by connecting the chapter segments and feature peak segments illustrated in FIG. 19 is illustrated below. The effect adding unit 114 generates a digest approximately L seconds long, by connecting the chapter segments from the chapter segment extracting unit 111 and the feature peak segments from the feature peak segment extracting unit 113 in time sequence, as illustrated below in FIG. 24.

Now, the length L of the digest is determined by the number and length of the chapter segments extracted by the chapter segment extracting unit 111 and the number and length of the feature peak segments extracted by the feature peak segment extracting unit 113. Further, the user can set the length L of the digest using the operating unit 17, for example.

The operating unit 17 supplies the control unit 16 with operating signals corresponding to the setting operations of the length L by the user. The control unit 16 controls the digest generating unit 72 based on the operating signals from the operating unit 17, so that the digest generating unit 72 generates a digest of the length L set by the setting operation. The digest generating unit 72 accordingly extracts chapter segments and feature peak segments until the total length (sum of lengths) of the extracted segments reaches the length L.

In this case, the digest generating unit 72 preferably extracts chapter segments from each chapter with priority, and thereafter extracts feature peak segments, so that at least chapter segments are extracted from the chapters. Alternatively, an arrangement may be made wherein, for example, at the time of extracting feature peak segments after having extracted the chapter segments from each chapter with priority, the digest generating unit 72 extracts feature peak segments from one or multiple sets of feature time-series data in the order of greatest maximums.

Further, an arrangement may be made wherein, for example, the user uses the operating unit 17 to perform setting operations to set a sum S of the length of segments extracted from one chapter, along with the length L of the digest, so that the digest generating unit 72 generates a digest of the predetermined length L. In this case, the operating unit 17 supplies control signals corresponding to the setting operations of the user to the control unit 16. The control unit 16 identifies the L and S set by the user, based on the operating signals from the operating unit 17, and calculates the total number of divisions D based on the identified L and S by inverse calculation.

That is to say, the total number of divisions D is an integer closest to L/S (e.g., L/S rounded off to the nearest integer). For example, let us consider a case where the user has set L=30 by setting operations, and has also performed settings such that a 7.5-second chapter segment and a 7.5-second feature peak segment are to be extracted from a chapter, i.e., such that S=15 (7.5+7.5). In this case, the control unit 16 calculates L/S=30/15=2 based on L=30 and S=15, and calculates 2, which is the integer value closest to L/S=2, as being the total number of divisions D.

The control unit 16 controls the dividing unit 71 such that the dividing unit 71 generates chapter point data corresponding to the calculated total number of divisions D. Accordingly, the dividing unit 71 generates chapter point data corresponding to the calculated total number of divisions D under control of the control unit 16, and supplies to the digest generating unit 72. The digest generating unit 72 generates a digest of the length L set by the user, based on the chapter point data from the dividing unit 71 and the content read out from the content storage unit 11, which is supplied to the content storage unit 11 to be stored.

Also, the effect adding unit 114 weights the audio data of each segment (chapter segments and feature peak segments) making up the digest with a weighting α as illustrated above in FIG. 24, and weights the BGM data by 1−α. The effect adding unit 114 then mixes the weighted audio data and weighted BGM, and correlates the mixed audio data obtained as the result thereof with each frame making up the digest, as audio data of the segments making up the digest. We will say that the effect adding unit 114 has BGM data held in unshown internal memory beforehand, and that the BGM to be added is specified in accordance with user operations.

That is to say, in the event of adding BGM to a chapter segment represented by white rectangles, for example, the effect adding unit 114 weights (multiplies) the audio data of the chapter segment with a weighting smaller than 0.5 so that the BGM volume can be set greater, for example. Specifically, in FIG. 24, the effect adding unit 114 weights the audio data of the chapter segment by 0.2, and weights the BGM data to be added by 0.8.

Also, in the event of adding BGM to a feature peak segment, extracted based on feature time-series data different from the audio power time-series data out of the from multiple feature time-series data, the effect adding unit 114 performs weighting in the same way as with a case of adding BGM to a chapter segment. Specifically, in FIG. 24, the effect adding unit 114 weights the audio data of the feature peak segment extracted based on the facial region time-series data (indicated by solid rectangles) by 0.2, and weights the BGM data to be added by 0.8.

Also, in the event of adding BGM to a feature peak segment extracted based on audio power time-series data (represented by hatched rectangles), for example, the effect adding unit 114 weights the audio data of the chapter segment with a weighting greater than 0.5 so that the BGM volume can be set smaller, for example. Specifically, in FIG. 24, the effect adding unit 114 weights the audio data of the feature peak segment extracted based on audio power time-series data by 0.8, and weights the BGM data to be added by 0.2.

Note that in the event that a chapter segment and a feature peak segment are extracted in an overlapping manner, as illustrated in FIG. 19, the chapter segment and feature peak segment are extracted as a single segment. In this case, the effect adding unit 114 uses the weighting to be applied to the feature peak segment of which the head frame point-in-time is temporally later, as the weighting to be applied to the audio data of the one segment made up of the chapter segment and feature peak segment.

Also, as illustrated above in FIG. 24, the effect adding unit 114 changes the switching of weightings continuously rather than non-continuously. That is to say, the effect adding unit 114 does not change the weighting of audio data of the digest from 0.2 to 0.8 in a non-continuous manner, but rather linearly changes from 0.2 to 0.8 over a predetermined amount of time (e.g., 500 milliseconds), for example. Further, the effect adding unit 114 may change the weighting nonlinearly rather than linearly, such as changing the weighting proportionately to time squared, for example. This can prevent the volume of the digest or the volume of the BGM from suddenly becoming loud, and thus sparing the user an unpleasant experience of sudden volume change.

### Description of Operation of Recorder 51

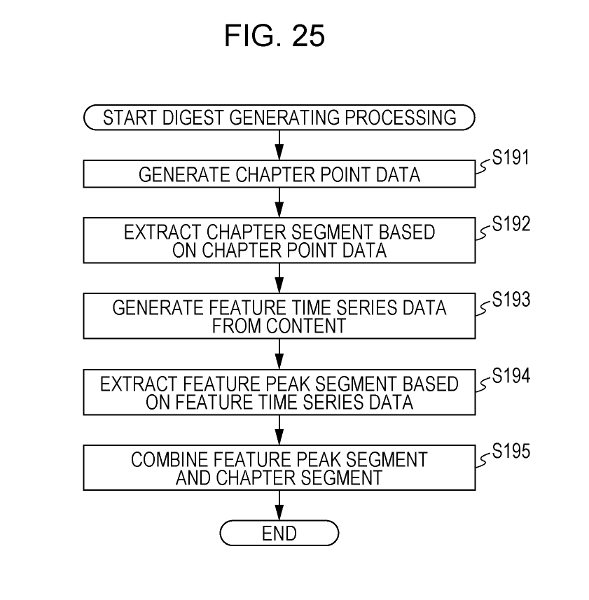

Next, the digest generating processing which the recorder 51 performs (in particular the dividing unit 71 and digest generating unit 72) will be described with reference to FIG. 25.

In step S191, the dividing unit 71 performs the same processing as with the dividing unit 15 in FIG. 1. The dividing unit 71 then generates chapter IDs to uniquely identify the head frame of each segment, from the content having been divided into multiple segments, as chapter point data. The dividing unit 71 supplies the generated chapter point data to the chapter segment extracting unit 111 and feature peak segment extracting unit 113 of the digest generating unit 72.

In step S192, the chapter segment extracting unit 111 identifies each chapter of the content supplied from the content storage unit 11, based on the chapter point data from the dividing unit 71. The chapter segment extracting unit 111 then extracts chapter segments from each identified chapter, representing the head portion of the chapter, and supplies to the effect adding unit 114.

In step S193, the feature extracting unit 112 extracts multiple sets of feature time-series data for example, from the content supplied from the content storage unit 11, and supplies this to the feature peak segment extracting unit 113. The feature extracting unit 112 may smooth the extracted feature time-series data using a smoothing filter, and supply the feature peak segment extracting unit 113 with the feature time-series data from which noise has been removed. The feature extracting unit 112 further supplies the feature peak segment extracting unit 113 with the content from the content storage unit 11 without any change.

In step S194, the feature peak segment extracting unit 113 identifies each chapter of the content supplied from the content storage unit 11 via the feature extracting unit 112, based on the chapter point data from the dividing unit 71. The feature peak segment extracting unit 113 also extracts a feature peak segment from each identified chapter, based on the multiple sets of feature time-series data supplied from the feature extracting unit 112, and supplies to the effect adding unit 114.

In step S195, the effect adding unit 114 connects the chapter segments and peak segments extracted as illustrated in FIG. 19, for example, in time sequence, thereby generating a digest. The effect adding unit 114 then includes BGM or the like in the generated digest, and supplies the digest with BGM added thereto to the content storage unit 11 so as to be stored. This ends the digest generating processing of FIG. 25.

As described above, with the digest generating processing, the chapter segment extracting unit 111 extracts chapter segments from each of the chapters. The effect adding unit 114 then generates a digest having at least the extracted chapter segments. Accordingly, by playing a digest, for example, the user can view or listen to a chapter segment which is the head portion of each chapter of the content, and accordingly can easily comprehend a general overview of the content.

Also, with the digest generating processing, the feature peak segment extracting unit 113 extracts feature peak segments based on multiple sets of feature time-series data, for example. Accordingly, a digest can be generated for the content regarding which a digest is to be generated, where a climax scene, for example, is included as a feature peak segment. Examples of feature peak segments extracted are scenes where the volume is great, scenes including zoom-in or zoom-out, scenes where there are a greater ratio of facial region, and so forth.

Also, the effect adding unit 114 generates a digest with effects such as BGM added, for example. Thus, according to the digest generating processing, a digest where what is included in the content can be understood more readily is generated. Further, weighting for mixing in BGM is gradually switched, thereby preventing the volume of the BGM or the volume of the digest suddenly becoming loud.

### 3. Third Embodiment

### Configuration Example of Recorder 131

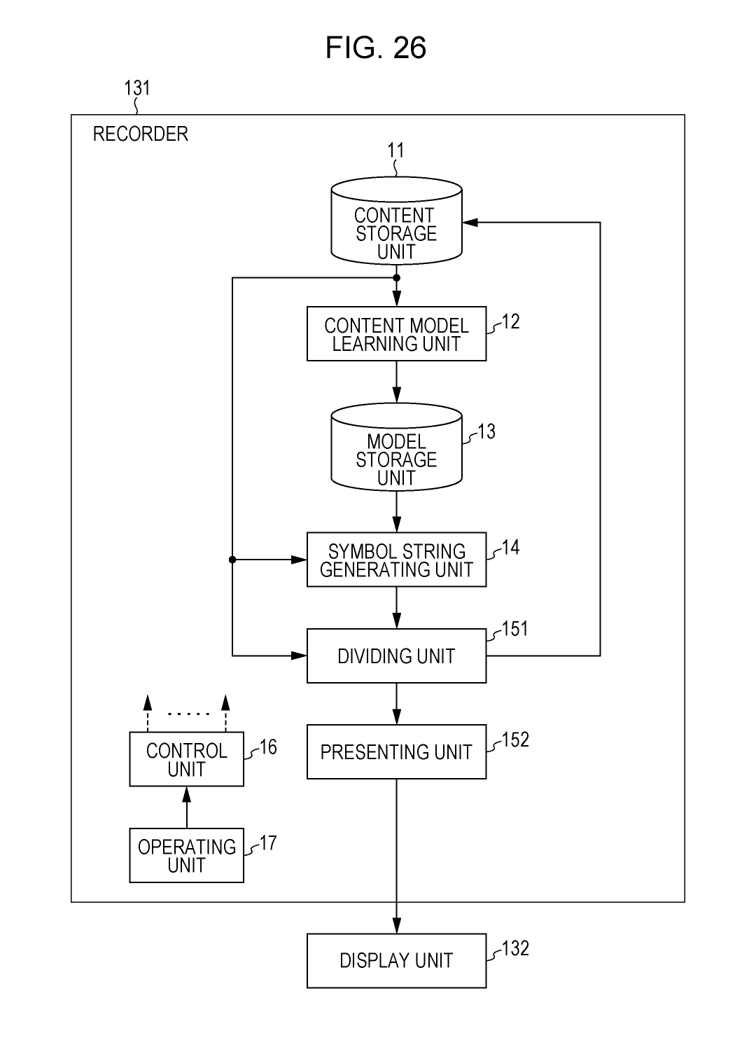

Now, it is preferable for the user to be able to easily play from a desired playing position when playing a content stored in the content storage unit 11. A recorder 131 which displays a display screen such that the user can easily search for a desired playing position will be described with reference to FIG. 26 through FIG. 41. FIG. 26 illustrates a configuration example of a recorder 131 according to a third embodiment.

Note that with the recorder 131, portions which are configured the same way as with the recorder 1 according to the first embodiment illustrated in FIG. 1 are denoted with the same reference numerals, and description thereof will be omitted as appropriate. That is to say, the recorder 131 is configured the same as with the recorder 1 in FIG. 1 except for a dividing unit 151 being provided instead of the dividing unit 15 in FIG. 1, and a presenting unit 152 being newly provided.

Further, a display unit 132 for displaying images is connected to the recorder 131. Also, while the digest generating unit 72 illustrated in FIG. 17 is omitted from illustration in FIG. 26, the digest generating unit 72 may be provided in the same way as with FIG. 17.

The dividing unit 151 performs dividing processing the same as with the dividing unit 15 in FIG. 1. The dividing unit 151 also generates chapter point data (chapter IDs) in the same way as with the dividing unit 71 in FIG. 17, and supplies to the presenting unit 152. Further, the dividing unit 151 correlates the symbols making up the symbol string supplied from the symbol string generating unit 14 with the corresponding frames making up the content, and supplies this to the presenting unit 152. Moreover, the dividing unit 151 supplies the content read out from the content storage unit 11 to the presenting unit 152.

The presenting unit 152 causes the display unit 132 to display each chapter of the content supplied from the dividing unit 151 in matrix form, based on the chapter point data also from the dividing unit 151. That is to say, the presenting unit 152 causes the display unit 132 to display the total number of divisions D chapters which change in accordance with user instruction operations using the operating unit 17, so as to be arrayed in matrix fashion, for example.

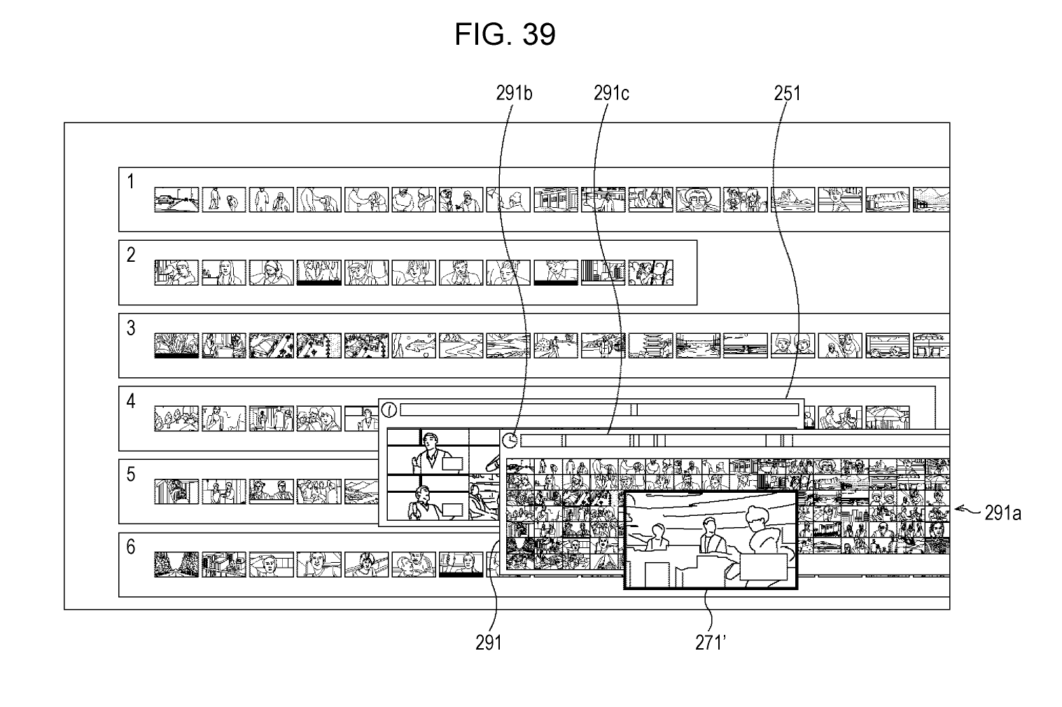

Specifically, in response to the total number of divisions D changing due to user instructing operations, the dividing unit 151 generates new chapter point data corresponding to the total number of divisions D after change, and supplies this to the presenting unit 152. Based on the new chapter point data supplied from the dividing unit 151, the presenting unit 152 displays the chapters of the total number of divisions D specified by the user specifying operations on the display unit 132. The presenting unit 152 also uses symbols from the dividing unit 151 to display frames having the same symbol as a frame selected by the user in tile form, as illustrated in FIG. 39 which will be described later.

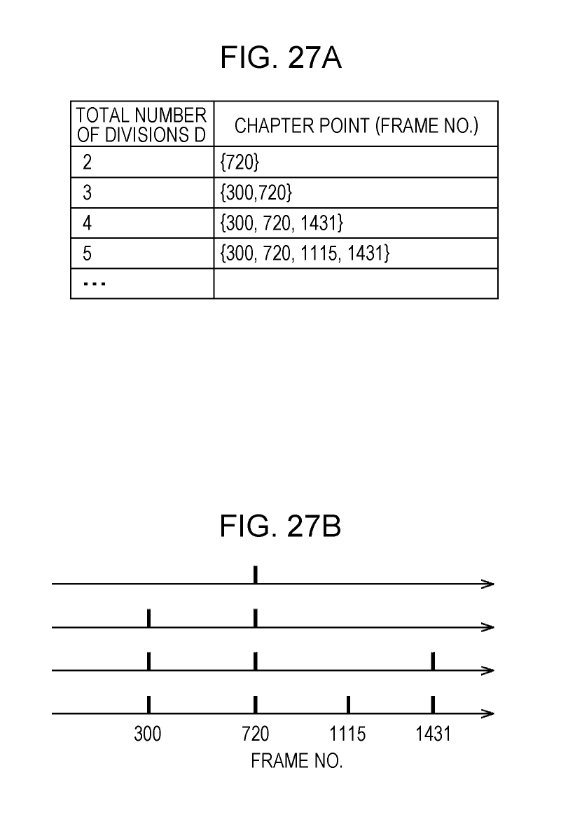

Next, FIGS. 27A and 27B illustrate an example of the way in which change in the total number of divisions D by user instruction operations causes the corresponding chapter point data to change. FIG. 27A illustrates an example of a combination between the total number of divisions D, and chapter point data corresponding to the total number of divisions D. Also, FIG. 27B illustrates an example of chapter points situated on the temporal axis of the content. Note that chapter points indicate, of the frames making up a chapter, the position where the head frame is situated.

As illustrated in FIG. 27A, when total number of divisions D=2, in addition to the frame of frame No. 0, the frame of frame No. 720 is also set as a chapter point. When total number of divisions D=2, the content is divided into a chapter of which the frame with frame No. 0 is the head, and a chapter of which the frame with frame No. 720 is the head, as can be seen from the first line in FIG. 27B. Note that frame No. 0 is a chapter point in any case, so frame No. 0 is omitted from illustration in FIGS. 27A and 27B.

Also, when changing the total number of divisions D=2 to total number of divisions D=3, the frame of frame No. 300 is additionally set as a chapter point. When total number of divisions D=3, the content is divided into a chapter of which the frame with frame No. 0 is the head, a chapter of which the frame with frame No. 300 is the head, and a chapter of which the frame with frame No. 720 is the head, as can be seen from the second line in FIG. 27B.

Also, when changing the total number of divisions D=3 to total number of divisions D=4, the frame of frame No. 1431 is additionally set as a chapter point. When total number of divisions D=4, the content is divided into a chapter of which the frame with frame No. 0 is the head, a chapter of which the frame with frame No. 300 is the head, a chapter of which the frame with frame No. 720 is the head, and a chapter of which the frame with frame No. 1431 is the head, as can be seen from the third line in FIG. 27B.

Further, when changing the total number of divisions D=4 to total number of divisions D=5, the frame of frame No. 1115 is additionally set as a chapter point. When total number of divisions D=5, the content is divided into a chapter of which the frame with frame No. 0 is the head, a chapter of which the frame with frame No. 300 is the head, a chapter of which the frame with frame No. 720 is the head, a chapter of which the frame with frame No. 1115 is the head, and a chapter of which the frame with frame No. 1431 is the head, as can be seen from the fourth line in FIG. 27B.

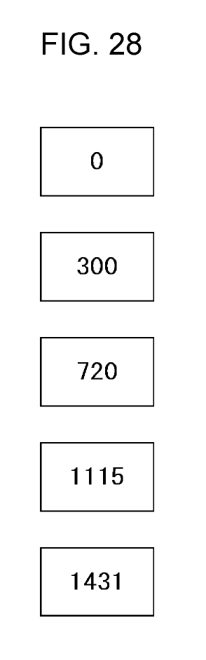

Next, processing of the presenting unit 152 generating display data for display on the display unit 132 will be described with reference to FIGS. 28 through 30. Note that description with FIGS. 28 through 30 will be made regarding a case of the presenting unit 152 generating display data in the case of the total number of divisions D=5.

FIG. 28 illustrates an example of frames which have been set as chapter points. Note that in FIG. 28, the rectangles represent frames, and the numbers described within the rectangles represent frame Nos.

The presenting unit 152 extracts the frames of frame Nos. 0, 300, 720, 1115, and 1431, which have been set as chapter points, from the content supplied from the dividing unit 151. Note that in this case, the chapter point data corresponds to total number of divisions D=5, with the frames of frame Nos. 0, 300, 720, 1115, and 1431 having been set as chapter points.

The presenting unit 152 reduces the extracted frames to from thumbnail images, and displays the thumbnail images on the display screen of the display unit 132 from top to bottom, in the order of frame Nos. 0, 300, 720, 1115, and 1431. The presenting unit 152 then displays frames making up the chapter, at 50-frame intervals for example, as thumbnail images, from the left to the right on the display screen of the display unit 132.

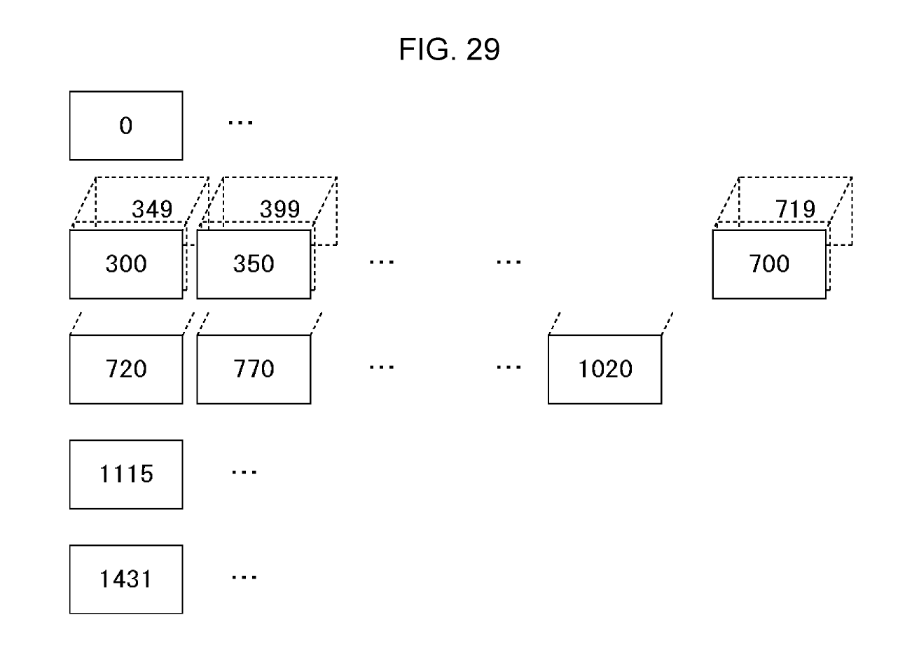

Next, FIG. 29 illustrates an example of thumbnail frames being displayed to the right side of frames set as chapter points, in 50-frame intervals. The presenting unit 152 extracts, from the content supplied from the dividing unit 151, the frame of frame No. 0 set as a chapter point, and also the frames of frame Nos. 50, 100, 150, 200, and 250, based on the chapter point data from the dividing unit 151.

The presenting unit 152 reduces the extracted frames to from thumbnail images, and displays the thumbnail images to the right direction from the frame of frame No. 0, in the order of frame Nos. 50, 100, 150, 200, and 250. The presenting unit 152 also displays thumbnail images of the frames of in the ascending order of frame Nos. 350, 400, 450, 500, 550, 600, 650, and 700, to the right direction from the frame of frame No. 300.

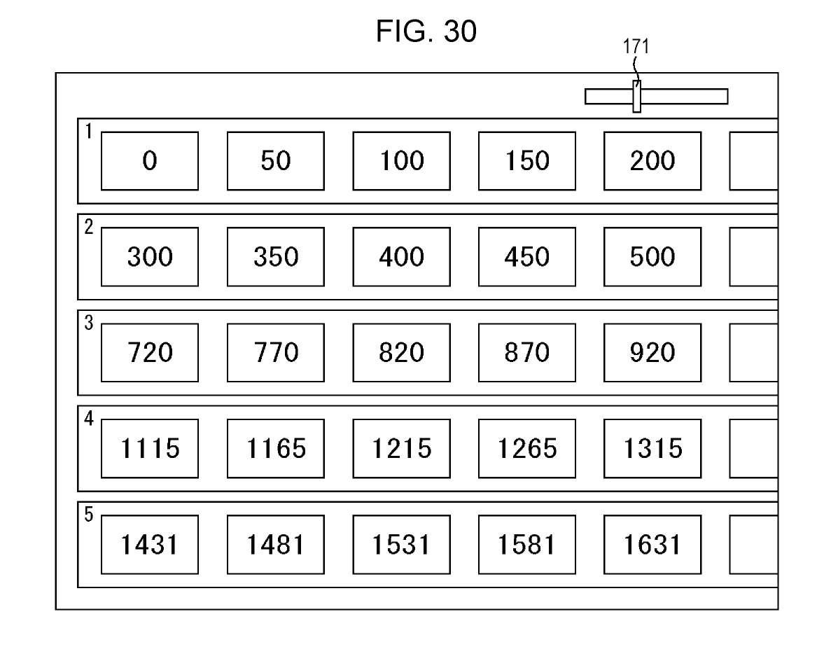

The presenting unit 152 also in the same way displays thumbnail images of the frames of in the ascending order of frame Nos. 770, 820, 870, 920, 970, 1020, and 1070, to the right direction from the frame of frame No. 720. The presenting unit 152 further displays thumbnail images of the frames of in the ascending order of frame Nos. 1165, 1215, 1265, 1315, 1365, and 1415, to the right direction from the frame of frame No. 1115. The presenting unit 152 moreover displays thumbnail images of the frames of in the ascending order of frame Nos. 1481, 1531, 1581, 1631, and so on, to the right direction from the frame of frame No. 1431. Thus, the presenting unit 152 can display a display with thumbnail images of the chapters arrayed in matrix fashion for each chapter, on the display unit 132, as illustrated in FIG. 30.

Note that the presenting unit 152 is not restricted to arraying thumbnail images of the chapters in matrix form, and may array the thumbnail images with over thumbnail images overlapping thereupon. Specifically, the presenting unit 152 may display the frame of the frame No. 300 as a thumbnail image, and situate thumbnail images of the frames of frame Nos. 301 through 349 so as to be hidden by the frame of the frame No. 300.

Next, FIG. 30 illustrates an example of the display screen on the display unit 132. As illustrated in FIG. 30, the display screen has thumbnail images of the chapters displayed in matrix fashion in chapter display regions provided for each chapter (horizontally extending rectangles which are indicated by chapter Nos. 1, 2, 3, 4, and 5).

That is to say, situated in the first row are the frames of frame Nos. 0, 50, 100, 150, 200, and so on, as thumbnail images of the first chapter 1 from the head of the content, in that order from left to right in FIG. 30. That is to say, the display unit 132 displays these thumbnail images as representative images representing the scenes of the chapter 1. Specifically, the display unit 132 displays the thumbnail image corresponding to the frame of frame No. 0 as a representative image representing a scene made up of the frames of frame Nos. 0 through 49. This is the same for chapters 2 through 5 illustrated in FIG. 30 as well.

Also, situated in the second row are the frames of frame Nos. 300, 350, 400, 450, 500, and so on, as thumbnail images of the second chapter 2 from the head of the content, in that order from left to right in FIG. 30. Further, situated in the third row are the frames of frame Nos. 720, 770, 820, 870, 920, and so on, as thumbnail images of the third chapter 3 from the head of the content, in that order from left to right in FIG. 30. Furthermore, situated in the fourth row are the frames of frame Nos. 1115, 1165, 1215, 1265, 1315, and so on, as thumbnail images of the fourth chapter 4 from the head of the content, in that order from left to right in FIG. 30. Moreover, situated in the fifth row are the frames of frame Nos. 1431, 1481, 1531, 1581, 1631, and so on, as thumbnail images of the fifth chapter 5 from the head of the content, in that order from left to right in FIG. 30.

Note that a slider 171 may be displayed on the display screen of the display unit 132, as illustrated in FIG. 30. This slider 171 is to be moved (slid) horizontally in FIG. 30 at the time of setting the total number of divisions D, and the total number of divisions D can be changed according to the position of the slider 171. That is to say, the further the slider 171 is moved to left the smaller the total number of divisions D is, and the further the slider 171 is moved to right the greater the total number of divisions D is.

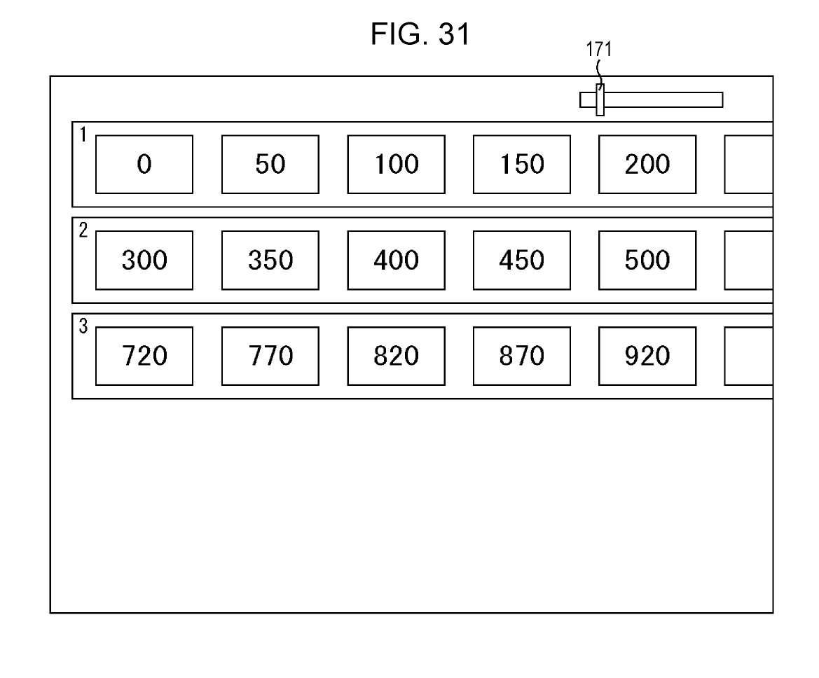

Accordingly, in the event that the user uses the operating unit 17 to perform an operation to move the slider 171 on the display screen illustrated in FIG. 30 to the left direction in the drawing, a display screen such as illustrated in FIG. 31 is displayed on the display unit 132 in accordance with the operation. In accordance with the slide operation using the slider 171, the dividing unit 151 generates chapter point data of the total number of divisions D corresponding to the slide operation, and supplies the generated chapter point data to the presenting unit 152. The presenting unit 152 generates a display screen such as illustrated in FIG. 31, based on the chapter pointer data from the dividing unit 151, and displays this on the display unit 132.

Also, an arrangement may be made where the dividing unit 151 generates chapter point data of the total number of divisions D each time the slide operation is performed by the user, in accordance with the slide operation, or chapter point data of multiple different the total number of divisions D may be generated beforehand. In the event of having generated chapter point data of multiple different total number of divisions D beforehand, the dividing unit 151 supplies the chapter point data of multiple different total number of divisions D to the presenting unit 152.

In this case, the presenting unit 152 selects, of the chapter point data of multiple different total number of divisions D supplied from the dividing unit 151, the chapter point data of the total number of divisions D corresponding to the slide operation made by the user using the slider 171. The presenting unit 152 then generates the display screen to be displayed on the display unit 132, based on the selected chapter point data, and supplies this to the display unit 132 to be displayed.

Next, FIG. 31 illustrates an example of a display screen displayed on the display unit 132 when the slider 171 has been moved in the direction of reducing the total number of divisions D. It can be seen from the display screen illustrated in FIG. 31 that the number of chapters (the total number of divisions D) has decreased from five to three, in comparison with the display screen illustrated in FIG. 30.

Also, an arrangement may be made where, for example, the presenting unit 152 extracts feature time-series data from the content provided from the dividing unit 151, in the same way as with the feature extracting unit 112 illustrated in FIG. 20. The presenting unit 152 may then visually signify thumbnail images displayed on the display unit 132 in accordance with the intensity of the extracted feature time-series data.

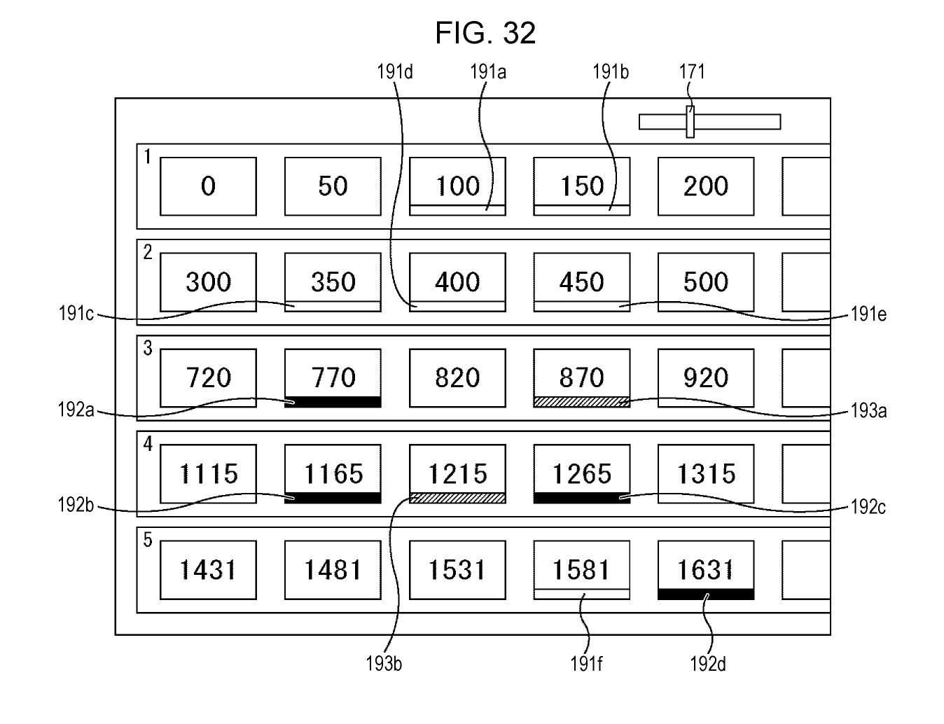

Next, FIG. 32 illustrates another example of the display screen on the display unit 132, where thumbnail images visually signified according to the intensity of the feature time-series data are displayed. Note that band displays are added to the thumbnail images displayed in FIG. 32, in accordance with the features of the scene including the frame corresponding to that thumbnail image (e.g., the 50 frames of which the frame corresponding to the thumbnail image is the head).

Band displays 191a through 191f are each added to thumbnail images representing scenes with a high ratio of facial regions. Here, the band displays 191a through 191f are added to the thumbnail images of frame Nos. 100, 150, 350, 400, 450, and 1581.

The band displays 192a through 192d are each added to thumbnail images representing scenes with a high ratio of facial regions, and also with relatively great audio power.

Also, the band displays 193a and 193b are each added to thumbnail images representing scenes with a relatively great audio power.

In the event that, of the frames making up a scene, the number of frames where the ratio of facial regions is at or above a predetermined threshold value, the band displays 191a through 191f are each added to thumbnail images representing this scene.

Alternatively, with band displays 191a through 191f, the floor of the band displays 191a through 191f may be made to be darker the greater the number of frames where the ratio of facial regions is at or above a predetermined threshold value is. This is true for the display bands 192a through 192d, and band displays 193a and 193b, as well.

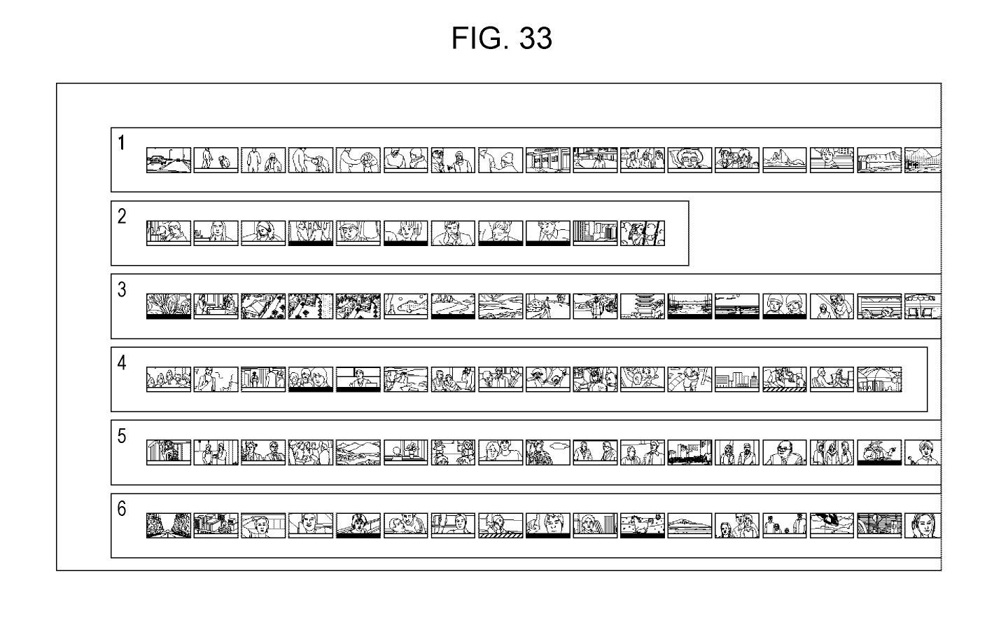

Also, while description has been made with FIG. 32 that a band display is added to a thumbnail image, a display of a human face may be made instead of the band displays 191a through 191f, for example. That is to say, any display method may be used for displaying as long as it represents the feature of that scene. Also, while frame Nos. are shown in FIG. 32 to identify the thumbnail images, the display screen on the display unit 132 is actually like that illustrated in FIG. 33.

### Details of Presenting Unit 152

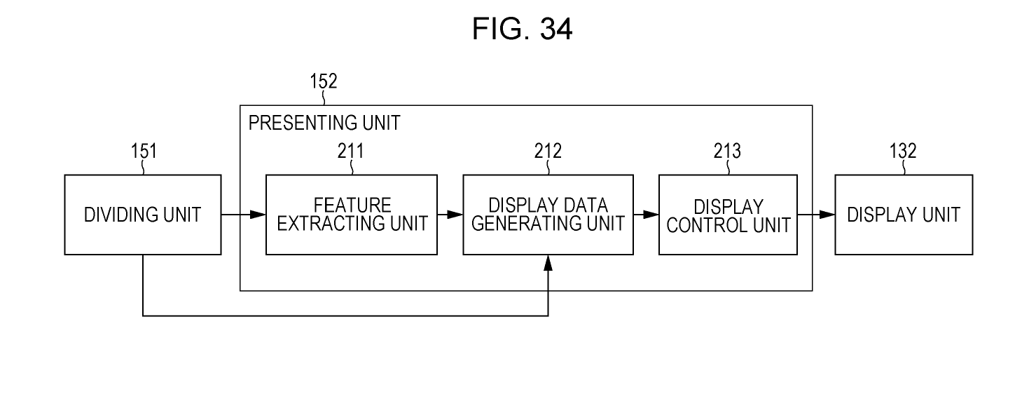

Next, FIG. 34 illustrates a detailed configuration example of the presenting unit 152 in FIG. 26. The presenting unit 152 is configured of a feature extracting unit 211, a display data generating unit 212, and a display control unit 213.

The feature extracting unit 211 is supplied with content from the dividing unit 151. The feature extracting unit 211 extracts feature time-series data in the same way as the feature extracting unit 112 illustrated in FIG. 20, and supplies this to the display data generating unit 212. That is to say, the feature extracting unit 211 extracts at least one of facial region time-series data, audio power time-series data, zoom-in intensity time-series data, and zoom-out time-series data, as feature time-series data, and supplies this to the display data generating unit 212.

The display data generating unit 212 is supplied with, in addition to the feature time-series data from the feature extracting unit 211, chapter point data from the dividing unit 151. The display data generating unit 212 generates display data to be displayed on the display screen of the display unit 132, such as illustrated in FIGS. 31 through 33, based on the feature time-series data from the feature extracting unit 211 and the chapter point data from the dividing unit 151.

The display control unit 213 causes the display screen of the display unit 132 to make a display such as illustrated in FIGS. 31 through 33, based on the display data from the display data generating unit 212.

It should be noted that the display data generating unit 212 generates display data corresponding to user operations, and supplies this to the display control unit 213. The display control unit 213 changes the display screen of the display unit 132 in accordance with user operations, based on the display data from the display data generating unit 212.

There are three modes in which the display control unit 213 performs display control of chapters of a content, which are layer 0 mode, layer 1 mode, and layer 2 mode. In layer 0 mode, the display unit 132 performs a display such as illustrated in FIGS. 31 through 33.

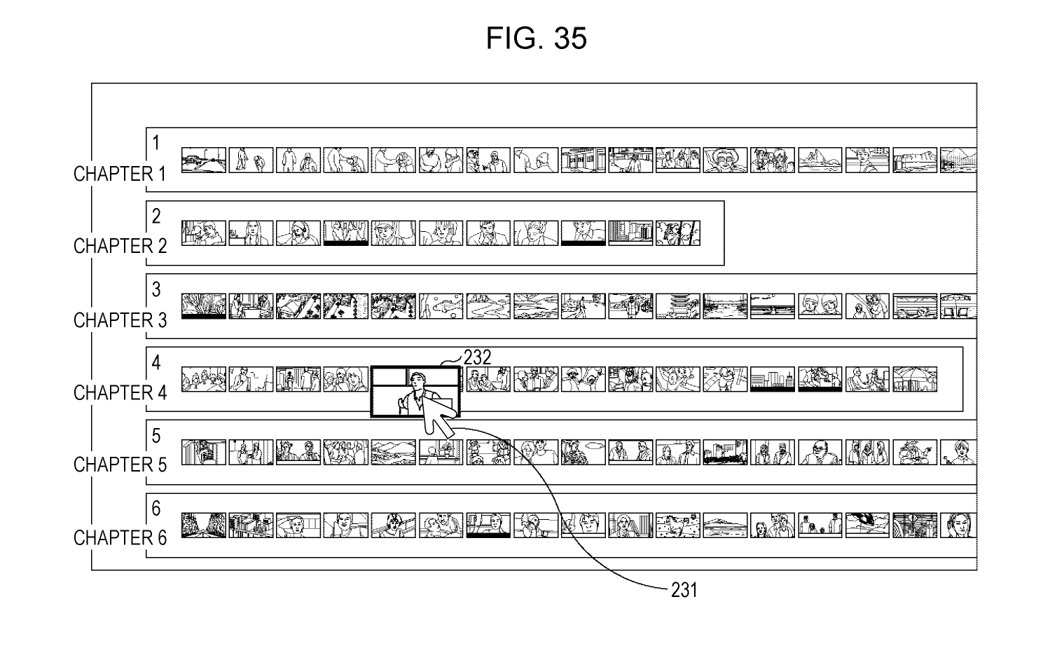

FIG. 35 illustrates an example of what happens when a user instructs a position on the display screen of the display unit 132 in layer 0 mode. Now, we will say that a mouse, for example, is used as the operating unit 17, to facilitate description. The user can use the operating unit 17 which is the mouse to perform single clicks and double clicks. The operating unit 17 is not restricted to a mouse.

In layer 0 mode, upon the user operating the operating unit 17 which is the mouse to move a pointer (cursor) 231 over the fifth thumbnail image from the left of chapter 4 in FIG. 35, the display control unit 213 changes the display of the display unit 132 to that such as illustrated in FIG. 35. That is to say, the thumbnail image 232 instructed by the pointer 231 is displayed in an enhanced manner. In the example in FIG. 35, the thumbnail image 232 instructed by the pointer 231 is displayed larger than the other thumbnail images, surrounded by a black frame, for example. Accordingly, the user can readily comprehend the thumbnail image 232 instructed by the pointer 231.

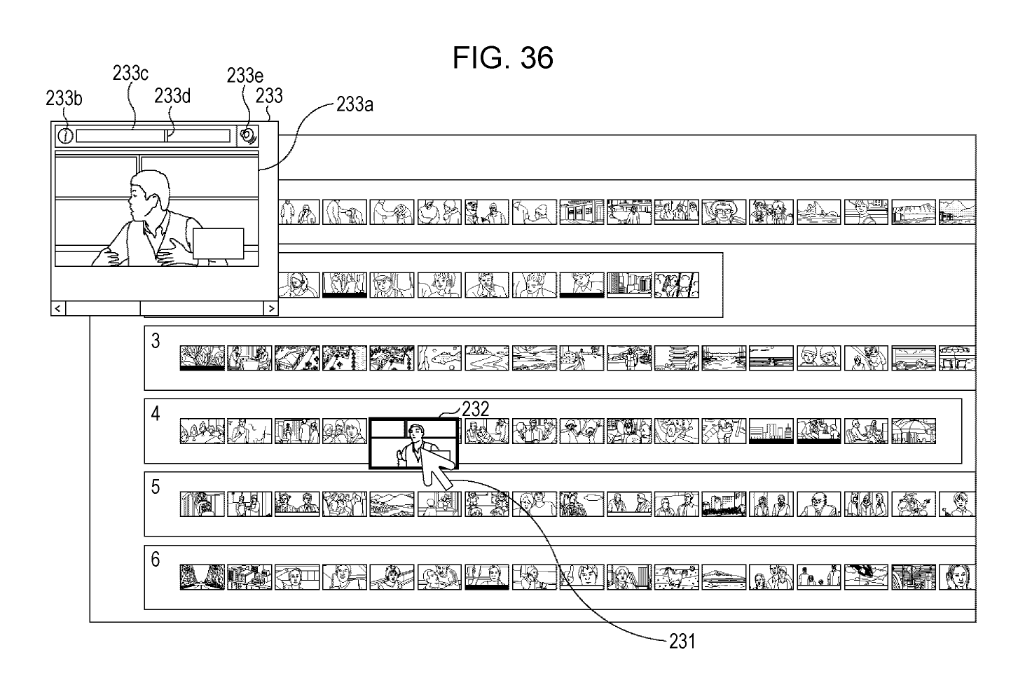

Next, FIG. 36 illustrates an example of what happens when double-clicking in the state of the thumbnail image 232 instructed by the pointer 231 in the layer 0 mode. In the event that the user double-clicks the mouse in the state of the thumbnail image 232 instructed by the pointer 231, the content is played from the frame corresponding to the thumbnail image 232. That is to say, the display control unit 213 displays a window 233 at the upper left of the display screen on the display unit 132, as illustrated in FIG. 36, for example. This window 233 has displayed therein content 233a played from the frame corresponding to the thumbnail image 232.

Also, in the window 233, there are situated, from the left to the right in FIG. 36, a clock mark 233b, a timeline bar 233c, a playing position display 233d, and a volume button 233e. The clock mark 233b is an icon displaying, with clock hands, the playing position (playing point-in-time) at which the content 233a is being played, out of the total playing time of the content 233a. Note that with the clock mark 233b, the total playing time of the content 233a is allocated one trip around a clock face (a metaphor of 0 through 60 minutes), for example.

The timeline bar 233c displays the playing position of the content 233a, in the same way as with the clock mark 233b. Note that the timeline bar 233c has the total playing time of the content 233a allocated fro the left edge to the right edge of the timeline bar 233c, with the playing position display 233d being situated at a position corresponding to the playing position of the content 233a. Note that in FIG. 36, the clock mark 233b may be configured as a slider which can be moved. In this case, the user can use the operating unit 17 to perform a moving operation of moving the playing position display 233d as a slider, and thus play the content 233a from the position of the playing position display 233d after having been moved.

The volume button 233e is an icon operated to mute or change the volume of the content 233a being played. That is to say, in the event that the user uses the operating unit 17 to move the pointer 231 over the volume button 233e and single-click on the volume button 233e, the volume of the content 233a being played is muted. Also, for example, in the event that the user uses the operating unit 17 to move the pointer 231 over the volume button 233e and double-clicks, a window for changing the volume of the content 233a being played is newly displayed.

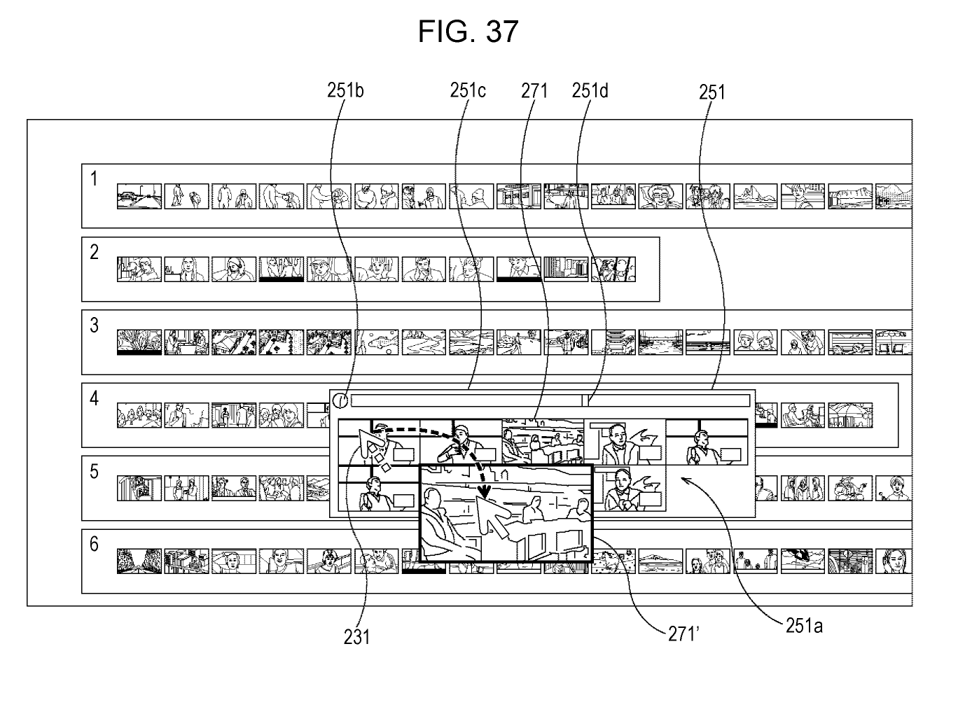

Next, in the event that the user single-clicks on the mouse in the state of the thumbnail image 232 instructed by the pointer 231 as illustrated in FIG. 35, in the layer 0 mode, the display control unit 213 transitions the display mode from the layer 0 mode to the layer 1 mode. The display control unit 213 then situates a window 251 at the lower side of the display screen in the display unit 132 as illustrated in FIG. 37, for example. Situated in this window 251 are a tiled image 251a, a clock mark 251b, a timeline bar 251c, and a playing position display 251d.

The tiled image 251a represents an image list of thumbnail images folded underneath the thumbnail image 232 (the thumbnail images of the scene represented by the thumbnail image 232). For example, in the event that the thumbnail image 232 is a thumbnail image corresponding to the frame of frame No. 300, the thumbnail image has folded underneath thumbnail images corresponding to the frames of frame Nos. 301 through 349, as illustrated in FIG. 29.

In the event that not all of the images in the list of thumbnail images folded underneath the thumbnail image 232 can be displayed as the tiled image 251a, a part of the thumbnail images may be displayed having been thinned out, for example. Alternatively, an arrangement may be made where a scroll bar is displayed in the window 251, so that all images of the list of thumbnail images folded underneath the thumbnail image 232 can be viewed by moving the scroll bar.

The clock mark 251b is an icon displaying the playing position of the frame being played that corresponds to the single-clicked thumbnail image, out of the total playing time of the content 233a, and is configured in the same way as with the clock mark 233b in FIG. 36. The timeline bar 251c displays the playing position of the frame being played that corresponds to the single-clicked thumbnail image, out of the total playing time of the content 233a, by way of the playing position display 251d, and is configured in the same way as with the timeline bar 233c in FIG. 36.

The timeline bar 251c further displays the playing position of the frames corresponding to the thumbnail images making up the tiled image 251a (besides the thumbnail image 232), using the same playing position display as with the playing position display 251d. With FIG. 37, only the playing position display 251d of the 232 is illustrated, and other playing position displays are not illustrated, to prevent the drawing from becoming overly complicated.

Upon the user performing a mouseover operation in which a certain thumbnail image of the multiple thumbnail images making up the tiled image 251a is instructed with the pointer 231 using the operating unit 17, the certain thumbnail image instructed by the pointer 231 is displayed in an enhanced manner. That is to say, upon the user performing a mouseover operation in which a thumbnail image 271 in the tiled image 251a is instructed with the pointer 231 using the operating unit 17, for example, a thumbnail image 271′ which is the enhanced 271 is displayed.

At this time, at the timeline bar 251c, the playing position display of the thumbnail image 271′ is displayed in an enhanced manner, in the same way as with the thumbnail image 271′ itself. For example, the playing position display of the thumbnail image 271′ is displayed in an enhanced manner in a different color from other playing position displays.

Also, with the timeline bar 251c, the playing display position displayed in an enhanced manner may be configured to be movable as a slider. In this case, by performing a moving operation of moving the enhance-displayed playing position display as a slider using the operating unit 17, the user can display a scene represented by a thumbnail image corresponding to the playing position display after moving, as the tiled image 251a, for example. Note that the thumbnail image 271 may be displayed enhanced according to the same method as with the thumbnail image 232 described with reference to FIG. 35, besides displaying the enhanced thumbnail image 271′.

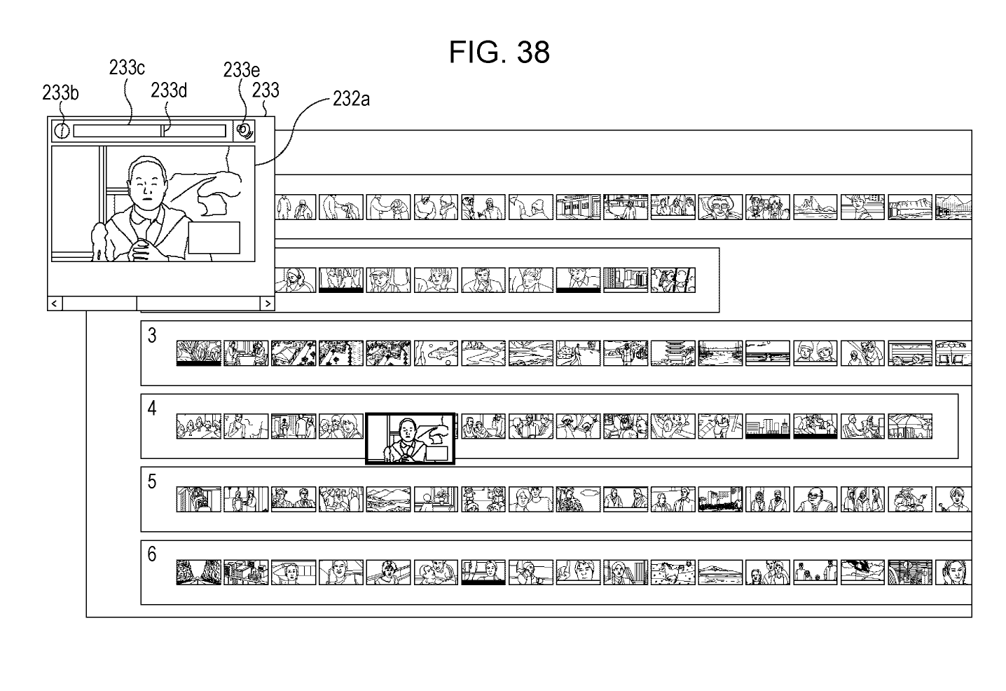

Upon the user double-clicking using the operating unit 17 in a state where the enhance-displayed thumbnail image 271′ is instructed by the pointer 231 playing of the content 233a is started from the frame corresponding to the thumbnail image 271′ (271) as illustrated in FIG. 38. FIG. 38 illustrates an example of what happens when performing double-clicking in a state where the thumbnail image 271′ is instructed with the pointer 231 in the layer 1 mode.

In the event that the user double-clicks in a state where the thumbnail image 271′ is instructed with the pointer 231 (FIG. 37) in layer 1 mode, the display control unit 213 transitions the display mode from the layer 1 mode to the layer 0 mode. The display control unit 213 then displays a window 233 at the upper left of the display screen on the display unit 132, as illustrated in FIG. 38, for example. This window 233 has displayed therein content 233a played from the frame corresponding to the thumbnail image 271′ (271).

Next, FIG. 39 illustrates an example of what happens when single-clicking in the state of the thumbnail image 271′ instructed by the pointer 231 in the layer 1 mode. In the event that the user single-clicks the mouse in the state of the thumbnail image 271′ instructed by the pointer 231 (FIG. 37) in the layer 1 mode, the display control unit 213 transitions the display mode from the layer 1 mode to the layer 2 mode. The display control unit 213 then displays a window 291 in the display screen on the display unit 132, as illustrated in FIG. 39, for example. Situated in this window 291 are a tiled image 291a, a clock mark 291b, a timeline bar 291c.

The tiled image 291a represents an image list of thumbnail images in the same way as the display of the thumbnail image 271′ (271). That is to say, the tiled image 291a is a list of thumbnail images having the same symbol as the frame corresponding to the thumbnail image 271′, out of the frames making up the content 233a.

Note that the display data generating unit 212 is supplied with the content 233a and a symbol string of the content 233a, besides the chapter point data from the dividing unit 151. The display data generating unit 212 extracts frames having the same symbol as the symbol of the frame corresponding to the thumbnail image 271′, from the content 233a from the dividing unit 151, based on the symbol string from the dividing unit 151.

The display data generating unit 212 then takes the extracted frames each as thumbnail images, generates the tiled image 291a which is a list of these thumbnail images, and supplies display data including the generated tiled image 291a to the display control unit 213. The display control unit 213 then controls the display unit 132 Based on the display data from the display data generating unit 212 so as to display the window 291 including the tiled image 291a on the display screen display unit 132.

In the event that not all of the thumbnail images making up the tiled image 291a can be displayed, a scroll bar is displayed in the window 291. Alternatively a portion of the thumbnail images may be omitted such that the tiled image 291a fits in the window 291.

The clock mark 291b is an icon displaying the playing position of the frame being played that corresponds to the single-clicked thumbnail image 271′, out of the total playing time of the content 233a, and is configured in the same way as with the clock mark 233b in FIG. 36. The timeline bar 291c displays the playing position of the frame being played that corresponds to the single-clicked thumbnail image, out of the total playing time of the content 233a, and is configured in the same way as with the timeline bar 233c in FIG. 36. Accordingly, playing positions of a number equal to the number of the multiple thumbnail images serving as the tiled image 291a, for example are displayed in the timeline bar 291c.

Also, upon the user performing a mouseover operation in which a certain thumbnail image of the multiple thumbnail images making up the tiled image 291a is instructed with the pointer 231 using the operating unit 17, the certain thumbnail image instructed by the pointer 231 is displayed in an enhanced manner. At this time, at the timeline bar 291c, the playing position display of the thumbnail image instructed with the pointer 231 is displayed in an enhanced manner, such as being displayed in an enhanced manner in a different color from other playing position displays. In FIG. 39, the certain thumbnail image is displayed in an enhanced manner, in the same way as when the user performs a mouseover operation in which the thumbnail image 271 is instructed with the pointer 231 and the thumbnail image 271′ is displayed in FIG. 37.

Upon the user double-clicking using the operating unit 17 in a state where the enhance-displayed thumbnail image is instructed by the pointer 231, playing of the content 233a is started from the frame corresponding to the thumbnail image, in the same way as illustrated in FIG. 38.

### Description of Operation of Recorder 131

Next, the presenting processing which the recorder 131 in FIG. 26 (particularly the presenting unit 152) performs will be described. In step S221, the dividing unit 151 performs processing the same as with the dividing unit 15 in FIG. 1. Also, the dividing unit 151 generates chapter point data (chapter IDs) in the same way as with the dividing unit 71 in FIG. 17, and supplies to the display data generating unit 212 of the presenting unit 152. Further, the dividing unit 151 correlates the symbols making up the symbol string supplied from the symbol string generating unit 14 with the corresponding frames making up the content, and supplies this to the display data generating unit 212 of the presenting unit 152. Moreover, the dividing unit 151 supplies the content read out from the content storage unit 11 to the feature extracting unit 211 of the presenting unit 152.

In step S222, the feature extracting unit 211 extracts feature time-series data in the same way as with the feature extracting unit 112 illustrated in FIG. 20, and supplies this to the display data generating unit 212.

That is to say, the feature extracting unit 211 extracts at least one of facial region time-series data, audio power time-series data, zoom-in intensity time-series data, and zoom-out time-series data, as feature time-series data, and supplies this to the display data generating unit 212.

In step S223, the display data generating unit 212 generates display data to be displayed on the display screen of the display unit 132, such as illustrated in FIGS. 31 through 33, based on the feature time-series data from the feature extracting unit 211 and the chapter point data from the dividing unit 151, and supplies this to the display control unit 213. Alternatively, the display data generating unit 212 generates display data to be displayed on the display screen of the display unit 132 under control of the control unit 16 in accordance with user operations, and supplies this to the display control unit 213.

That is to say, as illustrated in FIG. 39, in the event that the user single-clicks in the state that the thumbnail image 271′ is instructed by the pointer 231, the display data generating unit 212 uses symbols from the dividing unit 151 to generate display data for displaying the window 291 including the tiled image 291a, and supplies this to the display control unit 213.

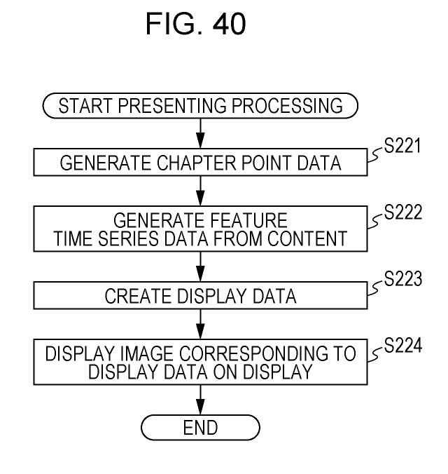

In step S224, the display control unit 213 causes the display screen of the display unit 132 to make a display corresponding to the display data, based on the display data from the display data generating unit 212. Thus, the presenting processing of FIG. 40 ends.

As described above, according to the presenting processing in FIG. 40, the display control unit 213 displays thumbnail images for each chapter making up the content, on the display screen of the display unit 132. Accordingly, the user can play the content from a desired playing position in a certain chapter, by referencing the display screen on the display unit 132.

Further, according to the presenting processing in FIG. 40, the display control unit 213 displays thumbnail images with band displays added. Accordingly, features of scenes corresponding to the thumbnail images can be readily recognized from the band display. Particularly, the user is not able to obtain information regarding audio from the thumbnail images, so adding a band display indicating the feature that the volume is great to the thumbnail image enables the feature of the scene to be readily recognized without having to play the scene.

Also, according to the presenting processing in FIG. 40, the display unit 132 displays thumbnail images of a scene represented by the thumbnail image 232 as the tiled image 251a along with the playing position thereof, as illustrated in FIG. 37 for example.

Also, according to the presenting processing in FIG. 40, the display control unit 213 causes display of thumbnail images of the frames having the same symbol as the symbol of the frame corresponding to the thumbnail image 271′, along with the playing position thereof, as the tiled image 291a as illustrated in FIG. 39 for example. Accordingly, the user can easily search for the playing position of a frame regarding which starting playing is desired, from the multiple frames making up the content 233a. Thus, the user can easily play the content 233a from the desired start position.

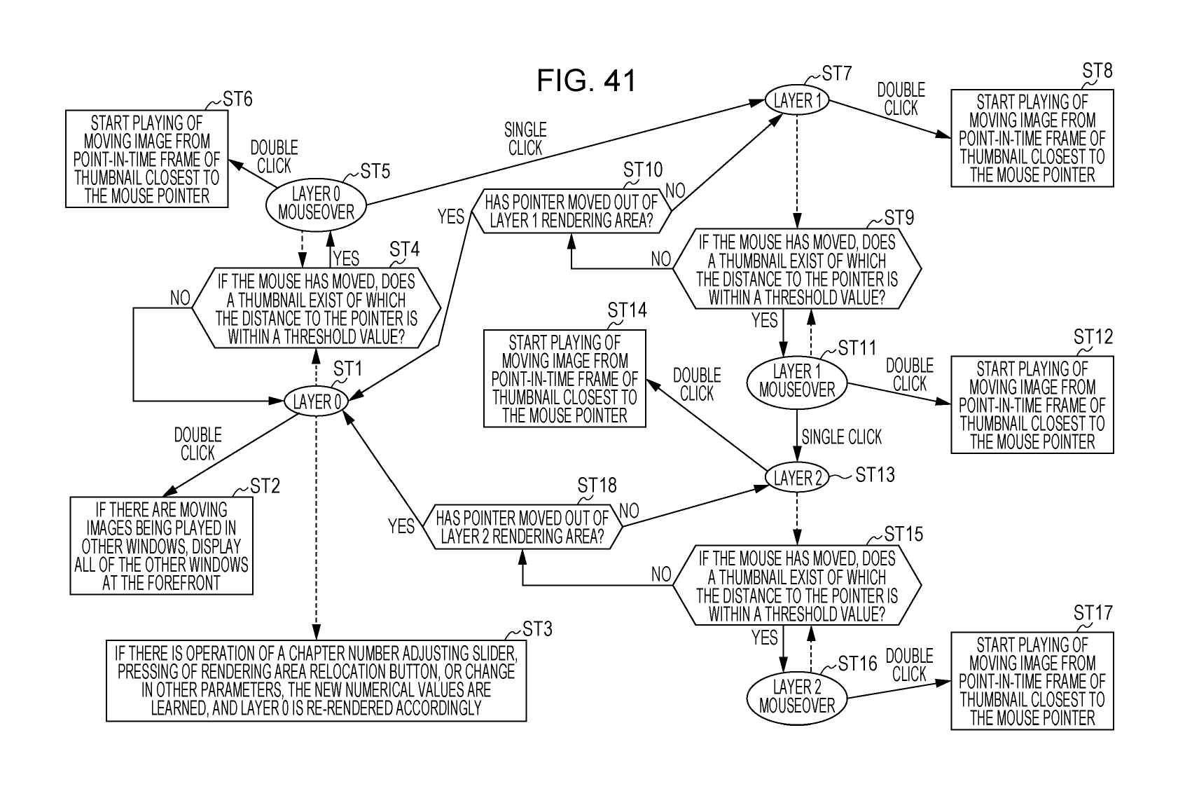

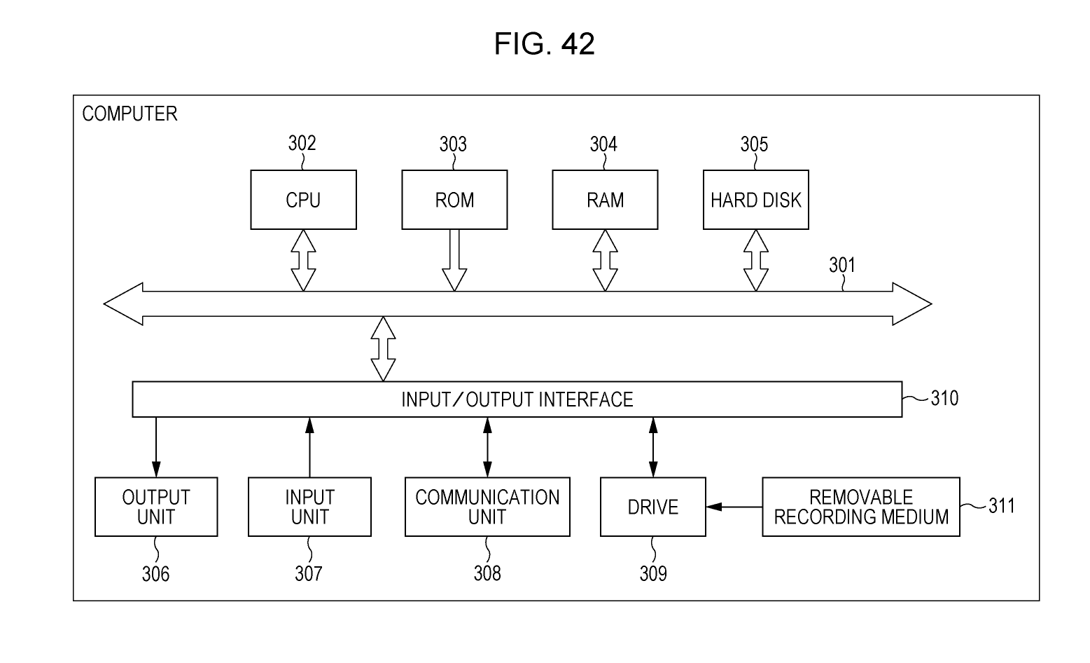

Next, FIG. 41 illustrates an example of the way in which the display modes of the display control unit 213 transition. In step ST1, the display mode of the display control unit 213 is layer 0 mode. Accordingly, the display control unit 213 controls the display unit 132 so that the display screen of the display unit 132 is such as illustrated in FIG. 33. For example, in the event that determination has been made that the user has used the operating unit 17 to perform a double-clicking operation in a state that none of the thumbnail images have been instructed with the pointer 231, based on operating signals from the operating unit 17, the flow advances from step ST1 to step ST2.

In step ST2, in the event that there exists a window 233 in which the content 233a is played, the control unit 16 controls the display data generating unit 212 so as to generate display data to display the window 233 at the forefront, and this is supplied to the display control unit 213. The display control unit 213 changes the display screen on the display unit 132 to a display screen where the window 233 is displayed at the forefront, based on the display data from the display data generating unit 212, and the flow returns from step ST2 to step ST1.

Also, the control unit 16 advances the flow from step ST1 to step ST3, if appropriate. In step ST3, the control unit 16 determines whether or not the user has performed a slide operation or the like of sliding the slider 171, based on operating signals from the operating unit 17. In the event of having determined that the user has performed a slide operation, based on the operating signals from the operating unit 17, the control unit 16 causes the display data generating unit 212 to generate display data corresponding to the slide operation or the like performed by the user, which is then supplied to the display control unit 213.

The display control unit 213 changes the display screen on the display unit 132 too the display screen according to the slide operation or the like performed by the user, based on the display data from the display data generating unit 212. Accordingly, the display screen on the display unit 132 is changed from the display screen illustrated in FIG. 30 to the display screen illustrated in FIG. 31, for example. Thereafter, the flow returns from step ST3 to step ST1.

Also, the control unit 16 advances the flow from step ST1 to step ST4, if appropriate. In step ST4, the control unit 16 determines whether or not there exists a thumbnail image 232 regarding which the distance as to the pointer 231 is within a predetermined threshold value, based on operating signals from the operating unit 17. In the event of having determined that such a thumbnail image 232 does not exist, the control unit 16 returns the flow to step ST1.

Also, in the event that determination is made in step ST4 that a thumbnail image 232 regarding which the distance as to the pointer 231 is within a predetermined threshold value, based on operating signals from the operating unit 17, the control unit 16 advances the processing to step ST5. Note that the distance between the pointer 231 and thumbnail image 232 means, for example, the distance between the center of gravity of the pointer 231 (or the tip portion of the pointer 231 in an arrow form) and the center of gravity of the thumbnail image 232.

In step ST5, the control unit 16 causes the display data generating unit 212 to generate display data for enhanced display of the thumbnail image 232, which is then supplied to the display control unit 213. The display control unit 213 changes the display screen displayed on the display unit 132 to the display screen such as illustrated in FIG. 35, based on the display screen from the display data generating unit 212.

Also, in step ST5, the control unit 16 determines whether or not one or the other of a double click or single click has been performed by the user using the operating unit 17, in a state in which the distance between the pointer 231 and the thumbnail image 232 is within the threshold value, based on the operating signals from the operating unit 17. In the event that the control unit 16 determines in step ST5 that neither a double click nor single click has been performed by the user using the operating unit 17, based on the operating signals from the operating unit 17, the flow is returned to step ST4 as appropriate.

On the other hand, in the event that the control unit 16 determines in step ST5 that a double click has been performed by the user using the operating unit 17, in a state in which the distance between the pointer 231 and the thumbnail image 232 is within the threshold value, based on the operating signals from the operating unit 17, the control unit 16 advances flow to step ST6.

In step ST6, the control unit 16 causes the display data generating unit 212 to generate the display data for playing the content 233a from the playing position of the frame corresponding to the thumbnail image 232, which is supplied to the display control unit 213. The display control unit 213 changes the display screen on the display unit 132 to the display screen such as illustrated in FIG. 36, and the flow returns to step ST1.

Also, in the event that the control unit 16 determines in step ST5 that a single click has been performed by the user using the operating unit 17, in a state in which the distance between the pointer 231 and the thumbnail image 232 is within the threshold value, based on the operating signals from the operating unit 17, the control unit 16 advances flow to step ST7.

In step ST7, the control unit 16 controls the display control unit 213 such that the display mode of the display control unit 213 is transitioned from layer 0 mode to layer 1 mode. Also, under control of the control unit 16, the display control unit 213 changes the display screen on the display control unit 213 to the display screen illustrated in FIG. 33 with the window 251 illustrated in FIG. 37 added thereto. Also, in step ST7, the control unit 16 determines whether or not a double click has been performed by the user using the operating unit 17, based on operating signals from the operating unit 17, and in the event that determination is made that a double click has been performed by the user, the flow advances to step ST8.

In step ST8, the control unit 16 causes the display data generating unit 212 to generate the display data for playing the content 233a from the playing position of the frame corresponding to the nearest thumbnail image 232 to the pointer 231, which is supplied to the display control unit 213. The display control unit 213 changes the display screen on the display unit 132 to the display screen such as illustrated in FIG. 36, and the flow returns to step ST1.

Also, in step ST7, in the event that the control unit 16 determines that a double click has not been performed by the user, based on operating signals from the operating unit 17, the flow advances to step ST9 if appropriate.

In step ST9, the control unit 16 determines whether or not there exists a thumbnail image 271 regarding which the distance as to the pointer 231 is within a predetermined threshold value, within the window 251 for example, based on operating signals from the operating unit 17. In the event of having determined that such a thumbnail image 271 does not exist, the control unit 16 advances the flow to step ST10.

In step ST10, the control unit 16 determines whether or not the pointer 231 has moved outside of the area of the window 251 displayed in layer 1 mode, based on operating signals from the operating unit 17, and in the event that determination is made that the pointer 231 has moved outside of the area of the window 251, the flow returns to step ST1.

In step ST1, the control unit 16 causes the display data generating unit 212 to generate display data for performing a display corresponding to the layer 0 mode, and supplies this to the display control unit 213. The display control unit 213 controls the display unit 132 so that the display screen of the display unit 132 changes to such as illustrated in FIG. 33, for example. In this case, the display control unit 213 transitions the display mode from layer 1 mode to layer 0 mode.

Also, in the event that determination is made in step ST10 that the pointer 231 has not moved outside of the area of the window 251, the flow returns to step ST7.

In step ST9, in the event that the control unit 16 determines that there exists a thumbnail image 271 regarding which the distance as to the pointer 231 is within a predetermined threshold value, within the window 251 for example, based on operating signals from the operating unit 17, the flow advances to step ST11.

In step ST11, the control unit 16 causes the display data generating unit 212 to generate display data for displaying the thumbnail image in an enhanced manner, and supplies this to the display control unit 213. The display control unit 213 changes the display screen of the display unit 132 to a display screen where a thumbnail image 271′ which is an enhanced thumbnail image 271 is displayed such as illustrated in FIG. 37.

Also, in step ST11, the control unit 16 determines whether or not one or the other of a double click or single click has been performed by the user using the operating unit 17, in a state in which the distance between the pointer 231 and the thumbnail image 271′ is within the threshold value, based on the operating signals from the operating unit 17. In the event that the control unit 16 determines in step ST11 that neither a double click nor single click has been performed by the user using the operating unit 17, based on the operating signals from the operating unit 17, the flow is returned to step ST9 as appropriate.

On the other hand, in the event that the control unit 16 determines in step ST11 that a double click has been performed by the user using the operating unit 17, in a state in which the distance between the pointer 231 and the thumbnail image 271′ is within the threshold value, based on the operating signals from the operating unit 17, the control unit 16 advances flow to step ST12.

In step ST12, the control unit 16 causes the display data generating unit 212 to generate the display data for playing the content 233a from the playing position of the frame corresponding to the thumbnail image 271′, which is supplied to the display control unit 213. The display control unit 213 changes the display screen on the display unit 132 to the display screen such as illustrated in FIG. 38, based on the display data from the display data generating unit 212, and the flow returns to step ST7.

Also, in the event that the control unit 16 determines in step ST11 that a single click has been performed by the user using the operating unit 17, in a state in which the distance between the pointer 231 and the thumbnail image 271′ is within the threshold value, based on the operating signals from the operating unit 17, the control unit 16 advances flow to step ST13.

In step ST13, the control unit 16 controls the display control unit 213 such that the display mode of the display control unit 213 is transitioned from layer 1 mode to layer 2 mode. Also, under control of the control unit 16, the display control unit 213 changes the display screen on the display control unit 213 to the display screen illustrated in FIG. 39 with the window 291 displayed. Also, in step ST13, the control unit 16 determines whether or not a double click has been performed by the user using the operating unit 17, based on operating signals from the operating unit 17, and in the event that determination is made that a double click has been performed by the user, the flow advances to step ST14.

In step ST14, the control unit 16 causes the display data generating unit 212 to generate the display data for playing the content 233a from the playing position of the frame corresponding to the thumbnail image 232, which is supplied to the display control unit 213. The display control unit 213 changes the display screen on the display unit 132 to the display screen such as illustrated in FIG. 36, and the flow returns to step ST1.

Also, in step ST13, in the event that the control unit 16 determines that a double click has not been performed by the user, based on operating signals from the operating unit 17, the flow advances to step ST15 if appropriate.

In step ST15, the control unit 16 determines whether or not there exists a certain thumbnail image (image included in the tiled image 291a) regarding which the distance as to the pointer 231 is within a predetermined threshold value, for example, based on operating signals from the operating unit 17. In the event of having determined that such a certain thumbnail image does not exist, the control unit 16 advances the flow to step ST16.

In step ST16, the control unit 16 causes the display data generating unit 212 to generate display data for displaying the certain thumbnail image of which the distance to the pointer 231 in the window 291 is within the threshold value, and supplies this to the display control unit 213. The display control unit 213 changes the display screen on the display unit 132 to a display screen where the certain thumbnail image is displayed in an enhanced manner.

Also, in step ST16, the control unit 16 determines whether or not a double click has been performed by the user using the operating unit 17 in a state where the distance between the pointer 231 and a thumbnail image is within the threshold value, based on operating signals from the operating unit 17, and in the event that determination is made that a double click has been performed by the user, the flow advances to step ST17.

In step ST17, the control unit 16 causes the display data generating unit 212 to generate the display data for playing the content 233a from the playing position of the frame corresponding to the thumbnail image, which is supplied to the display control unit 213. The display control unit 213 changes the display screen on the display unit 132 to the display screen such as illustrated in FIG. 36, and the flow returns to step ST1.

Also, in step ST15, in the event that the control unit 16 determines that there does not exist a certain thumbnail image (image included in the tiled image 291a) regarding which the distance as to the pointer 231 is within a predetermined threshold value, for example, based on operating signals from the operating unit 17, the control unit 16 advances the flow to step ST18.

In step ST18, the control unit 16 determines whether or not the pointer 231 has moved outside of the area of the window 291 displayed in layer 2 mode, based on operating signals from the operating unit 17, and in the event that determination is made that the pointer 231 has moved outside of the area of the window 291, the flow returns to step ST1.

In step ST1, the control unit 16 controls the display unit 132 so that the display mode transitions from layer 2 mode to layer 0 mode, and subsequent processing is performed in the same way.

Also, in the event that the control unit 16 determines in step ST18 that the pointer 231 has not moved outside of the area of the window 291 displayed in the layer 2 mode, based on the operating signals from the operating unit 17, the flow returns to step ST13, and subsequent processing is performed in the same way.

### 4. Modifications

The present technology may assume the following configurations.

(1) An information processing device including: a symbol string generating unit configured to generate a symbol string in which symbols representing attributes of a plurality of data are arrayed in time-series, based on time-series data configured of the plurality of data arrayed in time-series; and a dividing unit configured to divide the time-series data into a plurality of segments, based on dispersion of the symbols in the symbol string.

(2) The information processing device according to (1), wherein the dividing unit divides the time-series data at a position where the summation of entropy of the plurality of segments is smallest, based on dispersion of the symbols in a symbol string.

(3) The information processing device according to either (1) or (2), wherein the dividing unit divides the time-series data into segments of a number of divisions specified by specifying operations performed by a user.

(4) The information processing device according to (1), wherein the dividing unit divides the time-series data into segments of a number of divisions where the summation of entropy is smallest, based on dispersion of the symbols in the symbol string.

(5) The information processing device according to any one of (1) through (4), wherein the dividing unit divides the time-series data into a plurality of segments by repeatedly performing bisection processing which divides the time-series data, at a position where the summation of entropy of segments after division is smallest, based on dispersion of the symbols in the symbol string.

(6) The information processing device according to any one of (1) through (4), wherein the dividing unit divides the time-series data into a plurality of segments by performing annealing partitioning processing which changes a portion where the time-series data is optionally divided, to a position where the summation of entropy is smallest, based on dispersion of the symbols in the symbol string.

(7) The information processing device according to any one of (1) through (6), wherein the symbol string generating unit generates, of a plurality of clusters representing subspaces making up a feature space, a symbol string made up of a plurality of symbols representing clusters including features extracted from a plurality of data configuring the time-series data.

(8) The information processing device according to any one of (1) through (6), wherein the symbol string generating unit generates, of a plurality of different states, a symbol string configured of a plurality of symbols representing each state of the plurality of data configuring the time-series data.

(9) An information processing method of an information processing device, the method including: generating of a symbol string in which symbols representing attributes of a plurality of data are arrayed in time series, based on time-series data made up of a plurality of data arrayed in time-series; and dividing of the time-series data into a plurality of segments, based on dispersion of the symbols in the symbol string.

(10) A program causing a computer of an information processing device which divides data to function as: a symbol string generating unit configured to generate a symbol string in which symbols representing attributes of a plurality of data are arrayed in time-series, based on time-series data configured of a plurality of data arrayed in time-series; and a dividing unit configured to divide the time-series data into a plurality of segments, based on dispersion of the symbols in the symbol string.

Description of Computer with Present Technology being Applied

Next, the above-mentioned series of processing may be performed by hardware, or may be performed by software. In the event of performing the series of processing by software, a program making up the software thereof is installed into a general-purpose computer or the like.

Accordingly, FIG. 42 illustrates a configuration example of an embodiment of the computer into which the program that executes the above-mentioned series of processing is installed.

The program may be recorded in a hard disk 305 or ROM 303 serving as recording media housed in the computer beforehand.

Alternatively, the program may be stored (recorded) in a removable recording medium 311. Such a removable recording medium 311 may be provided as a so-called package software. Here, examples of the removable recording medium 311 includes a flexible disk, CD-ROM (Compact Disc Read Only Memory), MO (Magneto Optical) disk, DVD (Digital Versatile Disc), magnet disk, and semiconductor memory.

Note that, in addition to installing from the removable recording medium 311 to the computer as described above, the program may be downloaded to the computer via a communication network or broadcast network, and installed into a built-in hard disk 305. That is to say, the program may be transferred from a download site to the computer by radio via a satellite for digital satellite broadcasting, or may be transferred to the computer by cable via a network such as a LAN (Local Area Network) or the Internet.

The computer houses a CPU (Central Processing Unit) 302, and the CPU 302 is connected to an input/output interface 310 via a bus 301.

In the event that a command has been input via the input/output interface 310 by a user operating an input unit 307 or the like, in response to this, the CPU 132 executes the program stored in the ROM (Read Only Memory) 303. Alternatively, the CPU 302 loads the program stored in the hard disk 305 to RAM (Random Access Memory) 304 and executes this.

Thus, the CPU 302 performs processing following the above-mentioned flowchart, or processing to be performed by the configuration of the above-mentioned block diagram. For example, the CPU 302 outputs the processing results thereof from an output unit 306 via the input/output interface 310 or transmits from a communication unit 308, further records in the hard disk 305, and so forth as appropriate.

Note that the input unit 307 is configured of a keyboard, a mouse, a microphone, and so forth. Also, the output unit 306 is configured of a LCD (Liquid Crystal Display), a speaker, and so forth.

Here, with the present Specification, processing that the computer performs in accordance with the program does not necessarily have to be processed in time sequence along the sequence described as the flowchart. That is to say, the processing that the computer performs in accordance with the program also encompasses processing to be executed in parallel or individually (e.g., parallel processing or processing according to an object).

Also, the program may be processed by one computer (processor), or may be processed in a distributed manner by multiple computers. Further, the program may be transferred to a remote computer for execution.

Note that embodiments of the present disclosure are not restricted to the above-described embodiments, and that various modifications may be made without departing from the essence of the present disclosure.

The present disclosure contains subject matter related to that disclosed in Japanese Priority Patent Application JP 2012-074113 filed in the Japan Patent Office on Mar. 28, 2012, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing device comprising:
a symbol string generating unit configured to generate a symbol string in which symbols representing attributes of a plurality of data are arrayed in time-series, based on time-series data configured of the plurality of data arrayed in time-series; and
a dividing unit configured to divide the time-series data into a plurality of segments, based on dispersion of the symbols in the symbol string.

2. The information processing device according to claim 1, wherein the dividing unit divides the time-series data at a position where the summation of entropy of the plurality of segments is smallest, based on dispersion of the symbols in a symbol string.

3. The information processing device according to claim 1, wherein the dividing unit divides the time-series data into segments of a number of divisions specified by specifying operations performed by a user.

4. The information processing device according to claim 1, wherein the dividing unit divides the time-series data into segments of a number of divisions where the summation of entropy is smallest, based on dispersion of the symbols in the symbol string.

5. The information processing device according to claim 2, wherein the dividing unit divides the time-series data into a plurality of segments by repeatedly performing bisection processing which divides the time-series data, at a position where the summation of entropy of segments after division is smallest, based on dispersion of the symbols in the symbol string.

6. The information processing device according to claim 1, wherein the dividing unit divides the time-series data into a plurality of segments by performing annealing partitioning processing which changes a portion where the time-series data is optionally divided, to a position where the summation of entropy is smallest, based on dispersion of the symbols in the symbol string.

7. The information processing device according to claim 1, wherein the symbol string generating unit generates, of a plurality of clusters representing subspaces making up a feature space, a symbol string made up of a plurality of symbols representing clusters including features extracted from a plurality of data configuring the time-series data.

8. The information processing device according to claim 1, wherein the symbol string generating unit generates, of a plurality of different states, a symbol string configured of a plurality of symbols representing each state of the plurality of data configuring the time-series data.

9. An information processing method of an information processing device which divides data, the method comprising:
generating of a symbol string in which symbols representing attributes of a plurality of data are arrayed in time series, based on time-series data made up of a plurality of data arrayed in time-series; and
dividing of the time-series data into a plurality of segments, based on dispersion of the symbols in the symbol string.

10. A program causing a computer of an information processing device which divides data to function as:
a symbol string generating unit configured to generate a symbol string in which symbols representing attributes of a plurality of data are arrayed in time-series, based on time-series data configured of a plurality of data arrayed in time-series; and
a dividing unit configured to divide the time-series data into a plurality of segments, based on dispersion of the symbols in the symbol string.
